(19) United States
(12) Patent Application Publication
(10) Pub. No.: US 2010/0245877 A1
(43) Pub. Date: Sep. 30, 2010

(54) IMAGE PROCESSING APPARATUS, IMAGE FORMING APPARATUS AND IMAGE PROCESSING METHOD

(75) Inventors: Hongfeng Wei, Cerritos, CA (US); Michael Yeung, Mission Viejo, CA (US); Ajit Sodhi, Irvine, CA (US); William Su, Riverside, CA (US); Sameer Yami, Santa Clara, CA (US)

Correspondence Address: TUROCY & WATSON, LLP, 127 Public Square, 57th Floor, Key Tower, CLEVELAND, OH, 44114, US

(73) Assignees: Kabushiki Kaisha Toshiba, Tokyo (JP); Toshiba Tec Kabushiki Kaisha, Tokyo (JP)

(21) Appl. No.: 12/415,086

(22) Filed: Mar. 31, 2009

(51) Int. Cl. G06F 3/12; H04N 1/40; H04N 1/00

(52) U.S. Cl. 358/1.13; 358/448; 358/402

(57) ABSTRACT

An image processing apparatus, including: an input module configured to input an image and first character data, the first character data being associated with the image; a template database module configured to store a template, the template including information of an operation associated with second character data; a determination module configured to determine the template according to the first character data and the second character data; and a job server module configured to execute the operation included in the template for the image.

### TECHNICAL FIELD

Exemplary embodiments described herein relate to an image processing apparatus such as a scanning system for dealing with a plurality of documents.

### BACKGROUND

Currently, a scanning system allows a user to scan documents to a local storage on the scanning system, to a file share on a network, to e-mail, to document stores such as an e-filing system, and to enterprise applications. For each destination, the user manually taps on a control panel on the scanning system to select a destination, scan a document, and then select another destination and scan the next document and so on and so forth.

Moreover, the user selects a scan template or uses a default template to scan a document using current scanning systems. For different types of documents, scan settings are different; therefore, scan templates need to be selected and default scan settings can be altered. The user taps the control panel two times or more to select a scan template. It typically requires a user to tap the control panel about five times to change scan settings.

Furthermore, to scan multiple sets of documents to the same or different destinations, the user loads one set of documents and scans each set of documents at a time.

However, the user may load documents in different directions (i.e. up-side-down, or 90 degrees rotated), and the user manually rotates images that are different from others (i.e. 180 degrees rotation for up-side-down images) or the user makes sure all the pages are in the same direction before scanning.

Such repeated steps significantly slow down the scanning process, repeats unnecessary scans, and/or introduce many mistakes that ultimately waste a lot of users' time.

### SUMMARY

The following presents a simplified summary in order to provide a basic understanding of one or more aspects of the invention. This summary is not an extensive overview of the invention. It is not intended to identify key or critical elements, nor to delineate the scope of the claimed subject matter. Rather, the sole purpose of this summary is to present some concepts of the invention in a simplified form as a prelude to the more detailed description that is presented hereinafter.

According to an exemplary embodiment, one aspect of the invention is an image processing apparatus, including: an input module configured to input an image and first character data, the first character data being associated with the image; a template database module configured to store a template, the template including information of an operation associated with second character data; a determination module configured to determine the template according to the first character data and the second character data; and a job server module configured to execute the operation included in the template for the image.

Another aspect of the invention relates to a sheet folding apparatus, including: an input module configured to input an image and first character data, the first character data being associated with the image; a template database module configured to store a template, the template including information of an operation associated with second character data; a determination module configured to determine the template according to the first character data and the second character data; a job server module configured to create a print direction based on the operation included in the template for the image; and a printer configured to print the image based on the print direction.

Yet another aspect of the invention relates to an image processing method, including: inputting an image and first character data, the first character data being associated with the image; determining a template according to the first character data and a second character data, the template including information of an operation associated with the second character data; and executing the operation included in the template for the image.

To the accomplishment of the foregoing and related ends, the invention, then, comprises the features hereinafter fully described. The following description and the annexed drawings set forth in detail certain illustrative aspects of the invention. However, these aspects are indicative of but a few of the various ways in which the principles of the invention may be employed. Other aspects, advantages and novel features of the invention will become apparent from the following description when considered in conjunction with the drawings.

### BRIEF DESCRIPTION OF THE SEVERAL VIEWS OF THE DRAWINGS

The invention and attendant advantages therefore are best understood from the following description of the non-limiting embodiments when read in connection with the accompanying Figures, wherein:

FIG. 1 is a diagram illustrating an exemplary image processing apparatuses connecting to a network file device, a server, a client computer and a network printer via a network;

FIG. 2 is a diagram illustrating an exemplary hardware block diagram of an image processing apparatus;

FIG. 3 is a diagram illustrating an exemplary diagram of an operation panel displaying mode buttons on a touch panel;

FIG. 4 is a diagram illustrating an exemplary diagram of an operation panel displaying a character keyboard;

FIG. 5 is a diagram illustrating an exemplary diagram of an operation panel displaying mode buttons on a touch panel;

FIG. 6 is a diagram illustrating an exemplary diagram of an operation panel displayed upon an auto job separation config button being pushed;

FIG. 7 is a diagram illustrating an exemplary diagram of an operation panel displayed upon a job template config button being pushed;

FIG. 8 is a diagram illustrating an exemplary diagram of a configuration view for a print action;

FIG. 9 is a diagram illustrating an exemplary diagram of a configuration view for a file action;

FIG. 10 is a diagram illustrating an exemplary diagram of a configuration view for a send action;

FIG. 11 is a diagram illustrating another exemplary diagram of an operation panel displayed upon a job template config button being pushed;

FIG. 12 is a diagram illustrating another exemplary diagram of a configuration view for a send action;

FIG. 13 is a diagram illustrating an exemplary software system block diagram of an image processing apparatus;

FIG. 14 is a diagram illustrating an exemplary job separation;

FIG. 15 is a diagram illustrating an exemplary job separation;

FIG. 16 is a diagram illustrating an exemplary job separation;

FIG. 17 is a diagram illustrating an exemplary job separation;

FIG. 18 is a diagram illustrating an exemplary job separation;

FIG. 19 is a diagram illustrating an exemplary flowchart of an exemplary copying operation;

FIG. 20 is a diagram illustrating an exemplary flowchart of an exemplary copying operation;

FIG. 21 is a diagram illustrating a flowchart of an exemplary scanning to store operation;

FIG. 22 is a diagram illustrating a flowchart of an exemplary scanning to send operation;

FIG. 23 is a diagram illustrating a flowchart of an exemplary scanning operation;

FIG. 24 is a diagram illustrating a flowchart of an exemplary image rotation;

FIG. 25 is a diagram illustrating a flowchart of an exemplary multi image rotation;

FIG. 26 is a diagram illustrating a flowchart of an exemplary multi job printing;

FIG. 27 is a diagram illustrating a flowchart of an exemplary file operation;

FIG. 28 is a diagram illustrating a flowchart of an exemplary send operation;

FIG. 29 is a diagram illustrating a flowchart of an exemplary OCR operation;

FIG. 30 is a diagram illustrating a flowchart of an exemplary job separation;

FIG. 31 is a diagram illustrating a flowchart of an exemplary job template operation;

FIG. 32 is a diagram illustrating a flowchart of an exemplary auto job template determination;

FIG. 33 is a diagram illustrating a flowchart of an exemplary job template operation;

FIG. 34 is a diagram illustrating a flowchart of an exemplary auto job template determination; and

FIG. 35 is a diagram illustrating an exemplary diagram of an operation panel displayed upon an auto job separation config button being pushed.

### DETAILED DESCRIPTION

Provided are systems, devices, and methods for scan destination selection, multiple destination routing of scanned documents, scan template selection, batch processing, automatic job separation, and/or automatic image rotation. The systems, devices, and methods use, for example, OCR image pattern matching, or image searching can be used to minimize the manual settings input required for each scanning task a user engages an MFP (Multi Function Peripheral). Relying on automated systems and methods not only increases efficiency of use of an MFP, but also decreases errors associated with more complex individual task settings input by a user.

For example, one of possible embodiment may be an MFP including: a scanner configured to input an image and job template keyword, the job template keyword being associated with the image; a template database module configured to store a template including operations such as copying, scanning to store and scanning to send; a determination module configured to determine a template associated with the job template keyword from the template database module; and a job server module configured to execute the operation included in the template for the image.

Referring now to the Figures in which like reference numerals designate identical or corresponding parts throughout the several views.

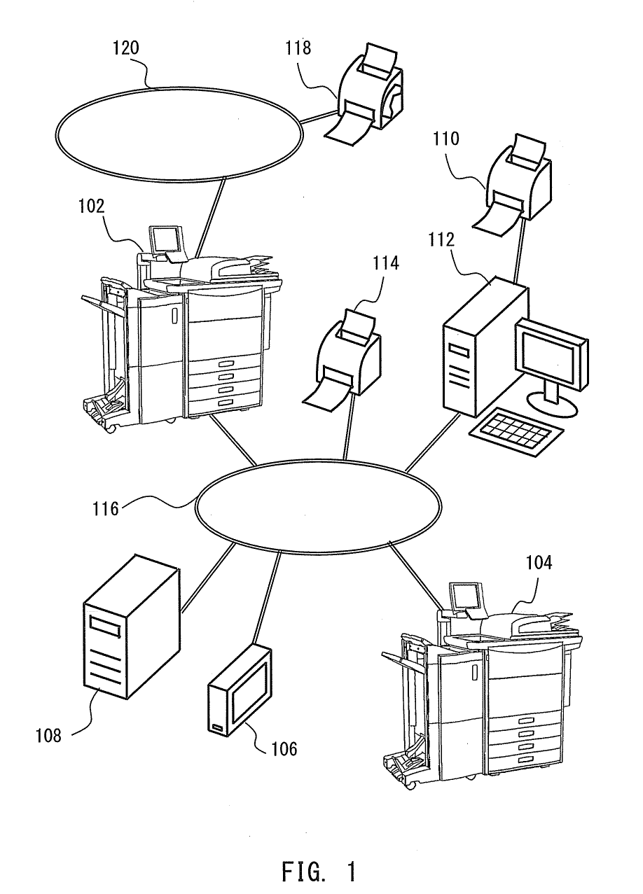

FIG. 1 illustrates an image processing apparatus 102 and 104 connecting to a network file device 106, a server 108, a client computer 112 and a network printer 114 via a network 116 and connecting to a fax machine 118 via a telecommunication network 120. The network 116 may be a Transmission Control Protocol (TCP) network. The image processing apparatus 102, the network file device 106, the server 108, the client computer 112 and the network printer 114 communicate with each other through the TCP network. The network 116 may be wired or wireless networks compliant with IEEE 802 standards. The image processing apparatus 102 may send a fax to the fax machine 118 via the telecommunication network 120.

The image processing apparatus 102 copies a sheet document to an output sheet. The image processing apparatus 102 processes post processing such as stapling, sort offset, punching and folding on the output sheet. The image processing apparatus 102 processes the post processing in units of a job. The image processing apparatus 102 scans sheet documents to create an electronic data file, also. The image processing apparatus 102 scans sheet documents to send facsimile messages, also. The image processing apparatus 102 connects to a network 116 to transmit information to and receive information from the image processing apparatus 104, the network file device 106 and the server 108.

The image processing apparatus 104 and the network printer 114 print an image obtained through the network 116 on an output sheet. The image processing apparatus 104 may scan sheet documents to create an electronic data file to transmit the electric data file to the image processing apparatus 104.

The network file device 106 stores the electric data file transferred from the image processing apparatus 102. The network file device 106 may support a network file system (NFS) protocol.

The server 108 can operate based on server software. The server 108 may be an e-mail server capable for communicating based on e-mail protocols such as Post Office Protocol (POP), Internet Message Access Protocol (IMAP) and Simple Mail Transfer Protocol (SMTP). The server 108 may be a file server capable of communicating based on network file transfer protocols such as File Transfer Protocol (FTP). The server 108 may support a network file system (NFS) protocol to work as a data file server.

The client computer 112 retrieves the electronic data file from the network file device 106, edits the electronic data file and updates the electronic data file in the network file device 106. The client computer 112 may communicate with the network file device 106 based on the NFS protocol and the file transfer protocols. The client computer 112 retrieves e-mail from the server 108 based on the e-mail protocols. The client computer 112 may work as a print server for a local printer 110 to print an image obtained through the network 116 on an output sheet.

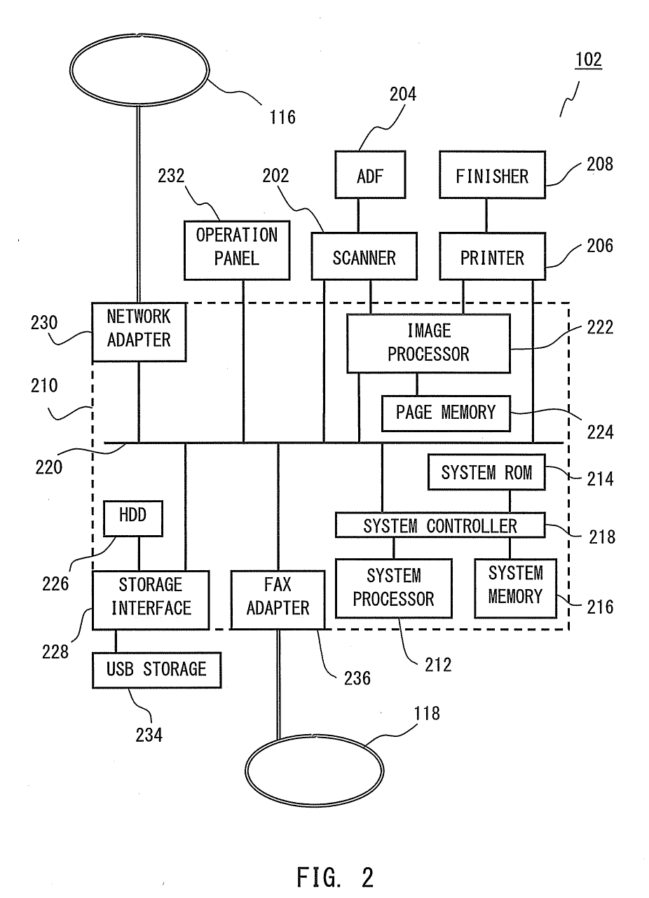

FIG. 2 illustrates an exemplary hardware block diagram of an image processing apparatus. The image processing apparatus 102 includes a scanner 202, an ADF (Auto Document Feeder) 204, a printer 206, a finisher 208 and a controller 210.

The scanner 202 set above the printer 206 scans an image of a sheet included in a manuscript to generate a scan image data to provide to the controller 210. The sheet is fed on the scanner 202 by the ADF 204. The ADF 204 may detect whether the manuscript includes a plurality of sheets or just a single sheet to create sheet number information. The ADF 204 may detect a length and a width of each sheet to create sheet size information. The sheet number information and the sheet size information may be provided from ADF 204 to the controller 210 through the scanner 202.

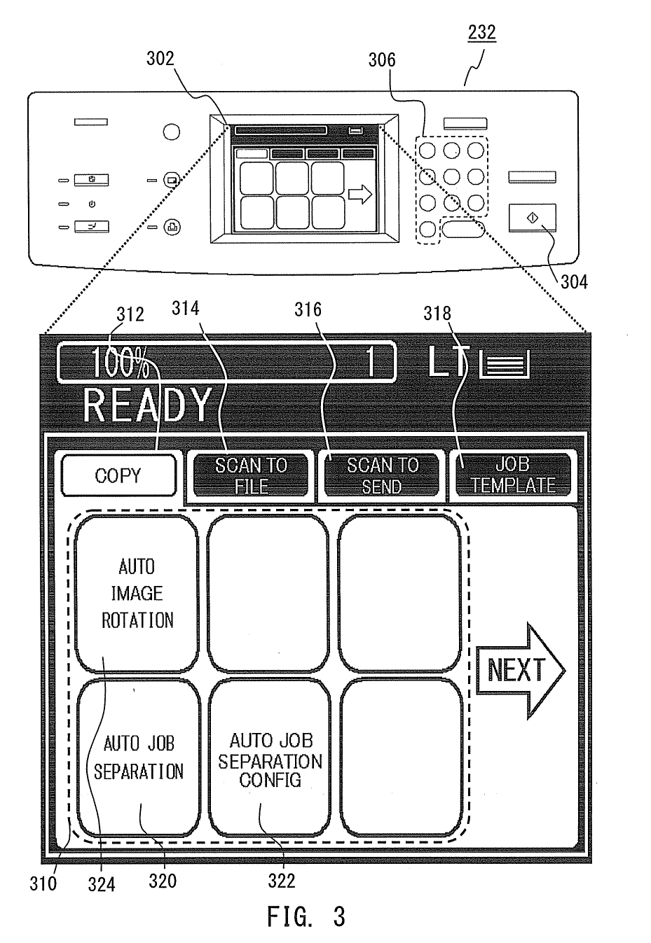

The printer 206 prints an image according to a raster image data provided by the controller 210. The printer 206 may have an operation panel 232. FIG. 3 through FIG. 10 illustrate exemplary diagrams of the operation panel 232. Although not shown, alternative operation panel orientations or alternative operation panels can be employed. The operation panel 232 includes a touch panel 302, an execution button 304 and number keys 306. The touch panel 302 can display job control tabs including a copy tab 312, a scan to file tab 314, a scan to send tab 316 and a job template tab 318.

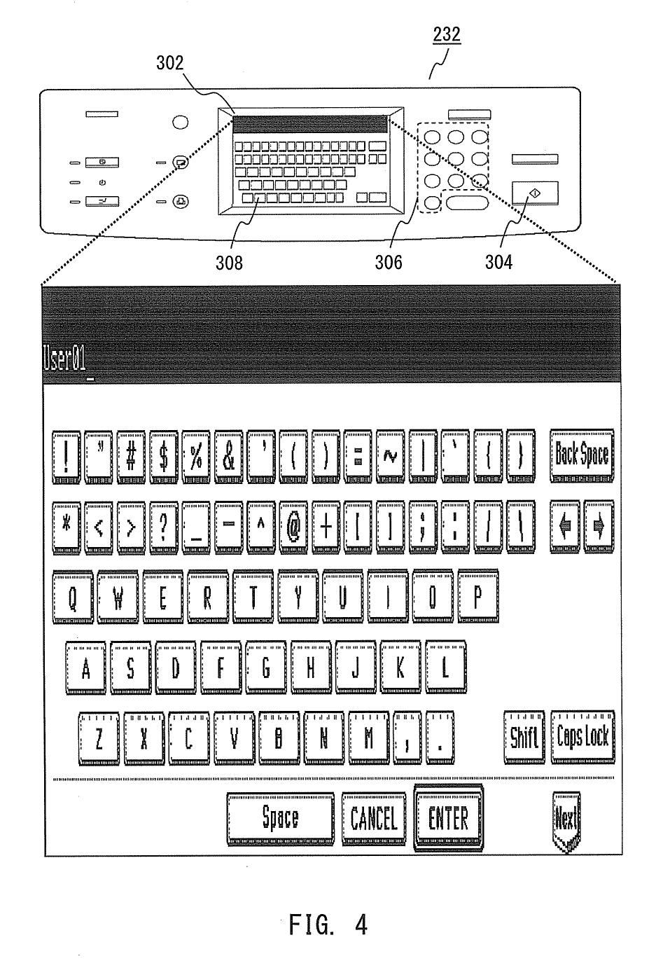

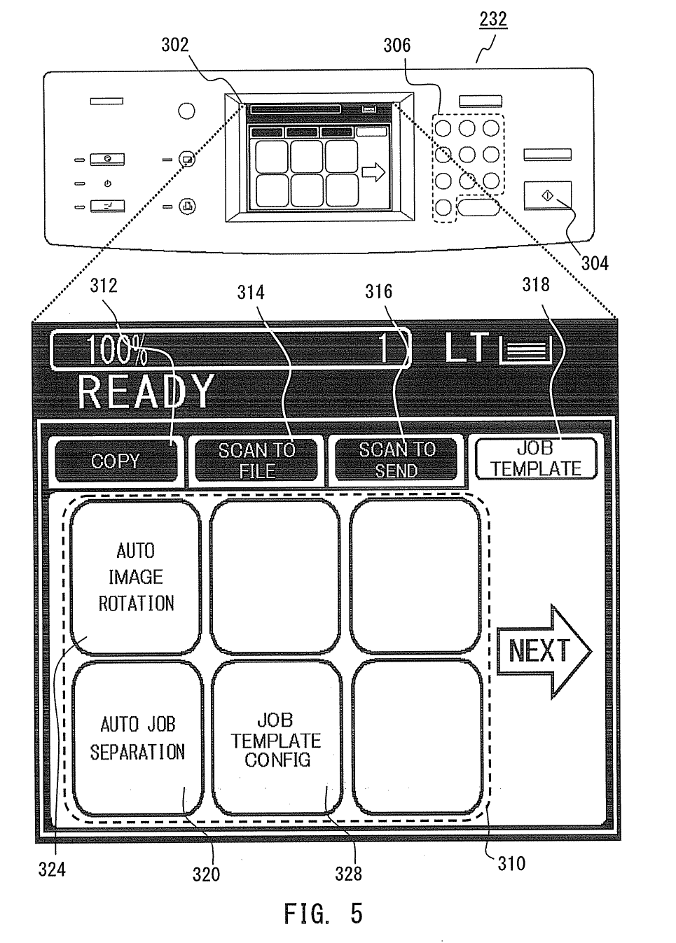

If one of the copy tab 312, the scan to file tab 314 and the scan to send tab 316 is selected, the touch panel 302 displays mode buttons 310 as shown in FIG. 3. The mode buttons may include one or more of an auto image rotation mode button 324, an auto job separation mode button 320, and an auto job separation config button 322. If the job template tab 318 is selected, the touch panel 302 displays mode buttons 310 as shown in FIG. 5. The mode buttons may include one or more of an auto image rotation mode button 324, an auto job separation mode button 320, and a job template config button 328. A condition of input from the number keys 306 and the mode buttons 310 may be stored in an input memory space on a system memory 216 or other memory. The condition of input from the number keys 306 may include a copy quantity. The touch panel 302 can display a character keyboard 308 as shown in FIG. 4. The input memory space can store character information input from the character keyboard 308. Character information of numerals can be input from the number keys 306. For example, the character information may stand for e-mail destinations.

The controller 210 may provide an instruction for finishing sheets discharged from the printer 206 to the finisher 208 through the printer 206. The finisher 208 may sort, staple, fold and process a saddle-stitch on the sheets discharged from the printer 206 according to the instruction.

The controller 210 can convert the scan image data to the raster image data, and can convert the scan image data into compressed image data. The controller 210 may store the compressed image data in an internal storage, and may transmit the compressed image data to other computing devices via the network by using protocols such as NFS, e-mail protocols, network file transfer protocols and others. The controller 210 may work as one of e-mail clients affiliated with the server 108 which works as a SMTP server. The controller 210 may work as a SMTP server for an e-mail client module running on the controller 210.

The controller 210 includes a system processor 212, a system ROM (Read Only Memory) 214, the system memory 216, a system controller 218, a bus 220, an image processor 222, a page memory 224, a HDD (Hard Disk Drive) 226, a storage interface 228, a network adapter 230, and a fax adapter 236.

The system processor 212 determines a direction input from the operation panel 232, and produces instructions for other components according to the direction and a programmed instruction stored in the system ROM 214. The system processor 212 uses the system memory 216 as a working memory space. The system processor 212 may work as a Raster Image Processor (RIP) that produces raster image data. The system processor 212 may work as a processor for Optical Character Recognition (OCR) that produces character data from the scan image data. The OCR may produce the character data from the raster image data. The OCR may produce the character data from an intermediate image data produced during conversion from the scan image data to the raster image data. Dictionary data for the OCR may be stored in the HDD 226 and read out to the system memory 216 to be used by the system processor 212 in the OCR. A controller-external OCR engine can be employed.

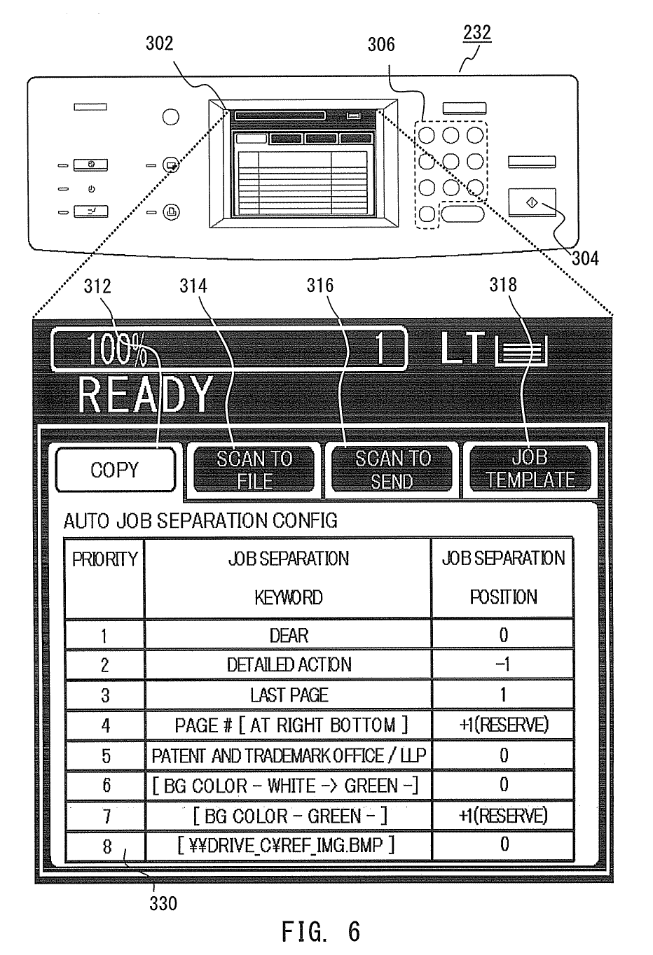

The HDD 226 also stores a dictionary for a job separation which includes a correspondence between character data and a job separation. FIG. 6 illustrates an exemplary diagram of the operation panel 232 displayed upon the auto job separation config button 322 being pushed. The operation panel 232 displays a table 330 indicating exemplary association between job separation keywords and job separation position. In this table, the number of the job separation position indicates a page difference between a page where the job separation keyword is found and a page from where another job starts. The associations are organized by priority.

Properties of a page may be associated with actions instead of, or with, job separation keywords. For example, the properties of a page may be a size of a page, a background color of a page, density of printing on a page, font size of printing on a page, and so on. On the table 330, a background color “GREEN” is associated with “+1(RESERVE)” which is a number of the job separation position. On the table 330, a transition of background color “WHITE→GREEN” is associated with “0” which is a number of the job separation position.

An image file may be associated with actions instead of, or with, job separation keywords as a job separation key image. For example, an image file may be associated by a path wherein the image file is stored. On the table 330, a path where the image file “¥¥DRIVE_C¥REF_IMG.BMP” is associated with “0” which is a number of the job separation position.

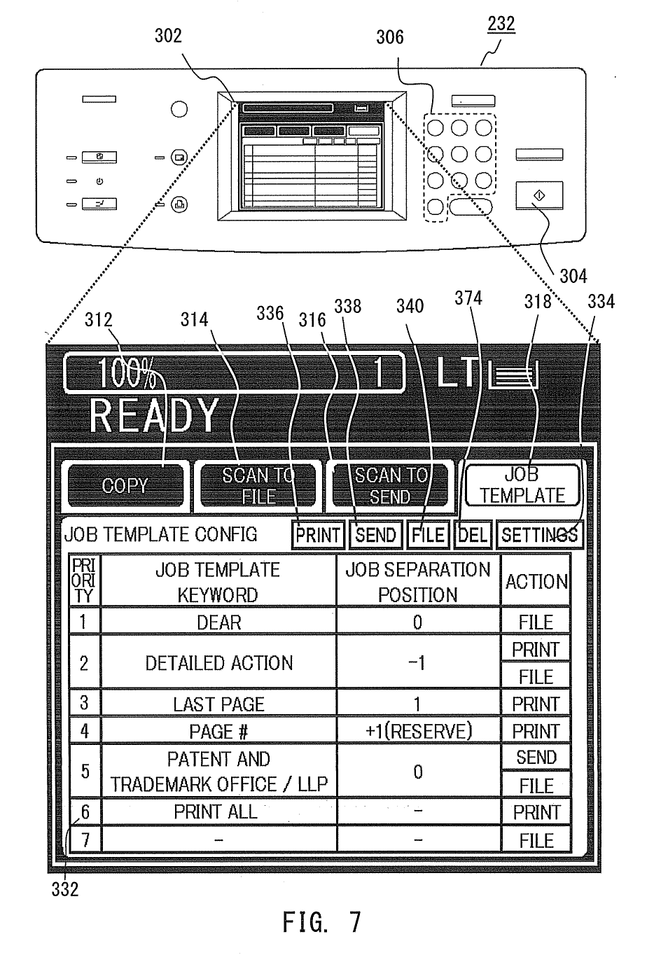

The HDD 226 further stores a dictionary for a job template which includes a correspondence of character data, a job separation, and an action. FIG. 7 illustrates an exemplary diagram of the operation panel 232 displayed upon the job template config button 328 being selected. The operation panel 232 displays a table 332 indicating exemplary association of job template keywords, job separation position and an action. The action may be one or more of printing, filing, sending an e-mail, and a fax. In this table, the number of the job separation position indicates a page difference between a page wherein the job template keyword is found and a page from where another job starts. The associations are organized by priority. The word in a column of action indicates an action for the job created by the job separation based on the job template keyword.

The operation panel 232 may display one or more of a settings button 334, a print action button 336, a send action button 338, a file action button 340 and an action delete button 374 with the table 332. The print action button 336 adds a print operation to a selected association of job template keywords and a job separation position. The send action button 338 adds a send operation to a selected association of job template keywords and a job separation position. The file action button 340 adds a file operation to a selected association of job template keywords and a job separation position. The action delete button 374 deletes a selected action from an association of job template keywords, a job separation position, and the selected action.

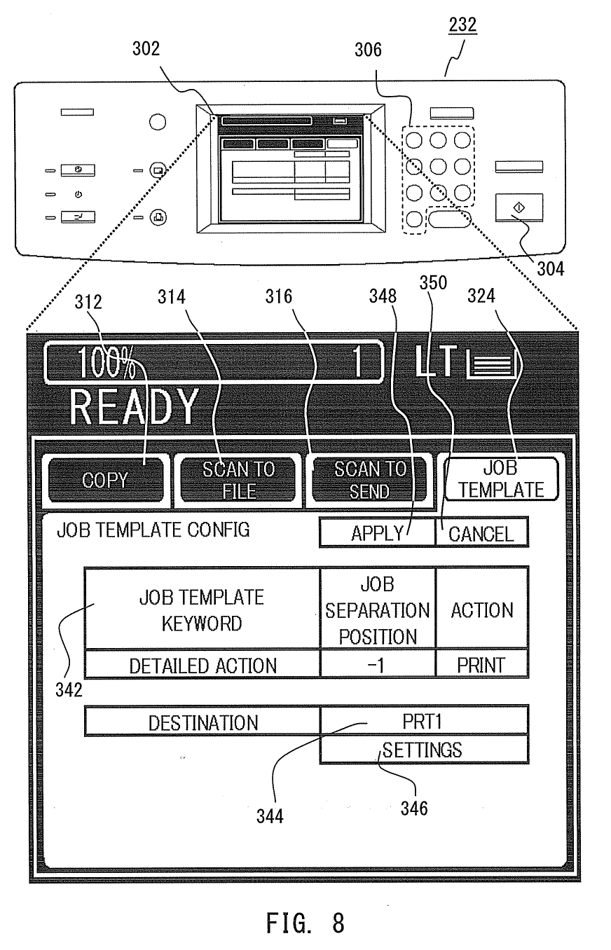

FIG. 8 illustrates an exemplary diagram of the configuration view for the print action. The configuration view for the print action may be called by a combination of pushing a cell containing a word “PRINT” in the table 332 and the settings button 334. The configuration view for the print action has a table 342, a destination row 344, a settings button 346, an apply button 348, and a cancel button 350. The table 342 displays information of a row of the table 332 which includes the cell selected upon calling the configuration view for the print action. The destination row 344 may be a dropdown list to select a name of a printer to print images according to the job created by a rule in the table 342. The destination row 344 in FIG. 8 indicates a name of printer “PRT1”. The dropdown list may list names of the image processing apparatus 104, the network printer 114 and the local printer 110 in this embodiment. The settings button 346 is displayed under the destination row 344 in FIG. 8. A printer driver window may be called by pushing the settings button 346. The printer driver window provides configuration of print settings for the printer selected on the destination row 344 upon the setting button 2524. The configuration of print settings may include configuring printing colors, sheet types, sheet orientations, duplication and post processing including stapling, sort offset, punching and folding on printed sheets. A printer selected at the destination row 344 and configuration set on the printer driver window may be stored in the HDD 226 upon selecting the apply button 348. The printer selected at the destination row 344 and the configuration set on the printer driver window may be stored in the HDD 226 without immediately sending the selection and settings to the printer. If the cancel button 350 is selected, the operation panel 232 may display the table 332 again without storing the printer selected at the destination row 344 and configuration set on the printer driver window.

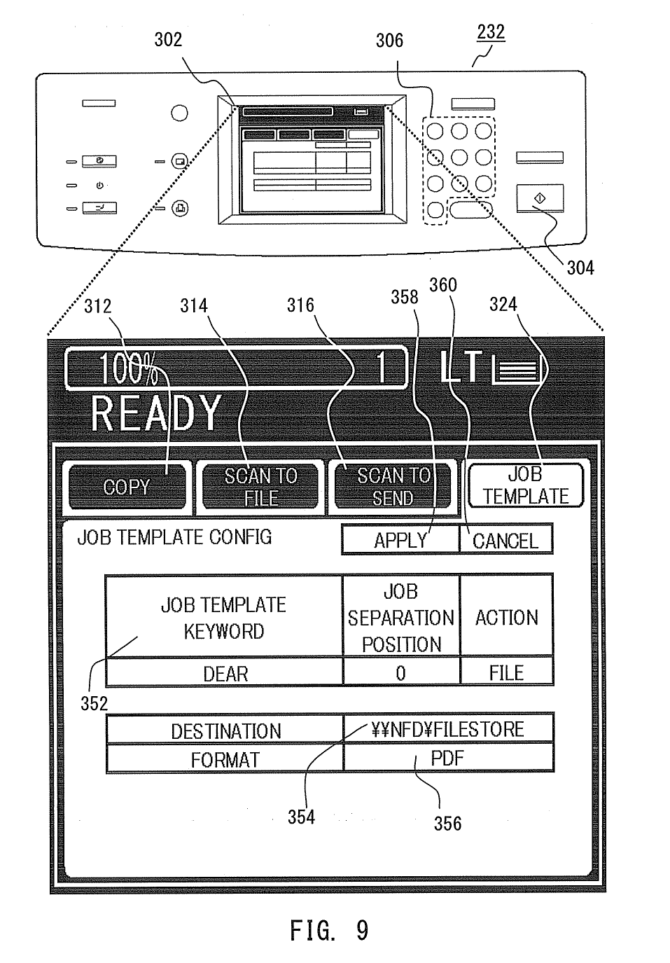

FIG. 9 illustrates an exemplary diagram of the configuration view for the file action. The configuration view for the file action may be called by a combination of pushing a cell containing a word “FILE” in the table 332 and the settings button 334. The configuration view for the file action has one or more of a table 352, a destination row 354, a format row 356, an apply button 358, and a cancel button 360. The table 352 displays information of a row of the table 332 which includes the cell selected upon calling the configuration view for the file action. The destination row 354 may display a path to store images included in the job created by the rule in the table 352. The destination row 354 in FIG. 9 indicates a path “¥¥NFD¥FILESTORE”. The indicated path may be pursuant to a file system supported by the controller 210 and the NFS. The character keyboard 308 shown in FIG. 4 may be displayed to input the path upon the destination row 354 being pushed. The format row 356 is displayed under the destination row 354 in FIG. 9. The format row 356 may be a dropdown list to select a file format to store images included in the job created by the rule in the table 352. The file format may be PDF, TIFF, JPEG, etc. The path input by the character keyboard 308 in the destination row 354 and the file format selected at the format row 356 may be stored in the HDD 226 upon selecting the apply button 358. If the cancel button 360 is pushed, the operation panel 232 may display the table 332 again without storing the path input by the character keyboard 308 in the destination row 354 and the file format selected at the format row 356.

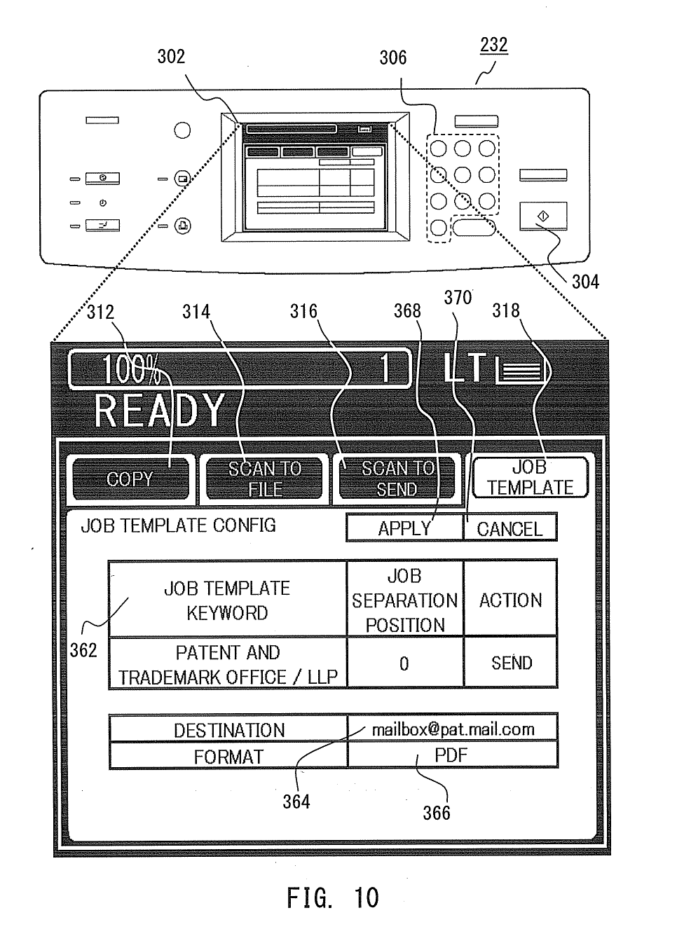

FIG. 10 illustrates an exemplary diagram of the configuration view for the send action. The configuration view for the send action may be called by a combination of selecting a cell containing a word “SEND” in the table 332 and the settings button 334. The configuration view for the send action has one or more of a table 362, a destination row 364, a format row 366, an apply button 368, and a cancel button 370. The table 362 displays information of a row of the table 332 which includes the cell selected upon calling the configuration view for the send action. The destination row 364 may display an e-mail address or a telephone/facsimile number to send images included in the job created by the rule in the table 362. The destination row 364 in FIG. 10 indicates an e-mail address “mailbox@pat.mail.com”. The e-mail address may be pursuant to the e-mail protocols. The destination row 364 may indicate a telephone number for faxing pursuant to ITU-T recommendations. The character keyboard 308 shown in FIG. 4 may be displayed to input the e-mail address and the telephone number upon the destination row 364 being pushed. The format row 366 is displayed under the destination row 364 in FIG. 10. The format row 366 may be enabled for sending e-mail, and may be disabled for sending fax. The format row 366 may be a dropdown list to select a file format to send images included in the job created by the rule in the table 362. The file format may be PDF, TIFF, JPEG, etc. The e-mail address or the telephone number input by the character keyboard 308 in the destination row 364 and the file format selected at the format row 366 may be stored in the HDD 226 upon the apply button 368 being pushed. If the cancel button 370 is pushed, the operation panel 232 may display the table 332 again without storing the e-mail address or the telephone number input by the character keyboard 308 in the destination row 364 and the file format selected at the format row 366.

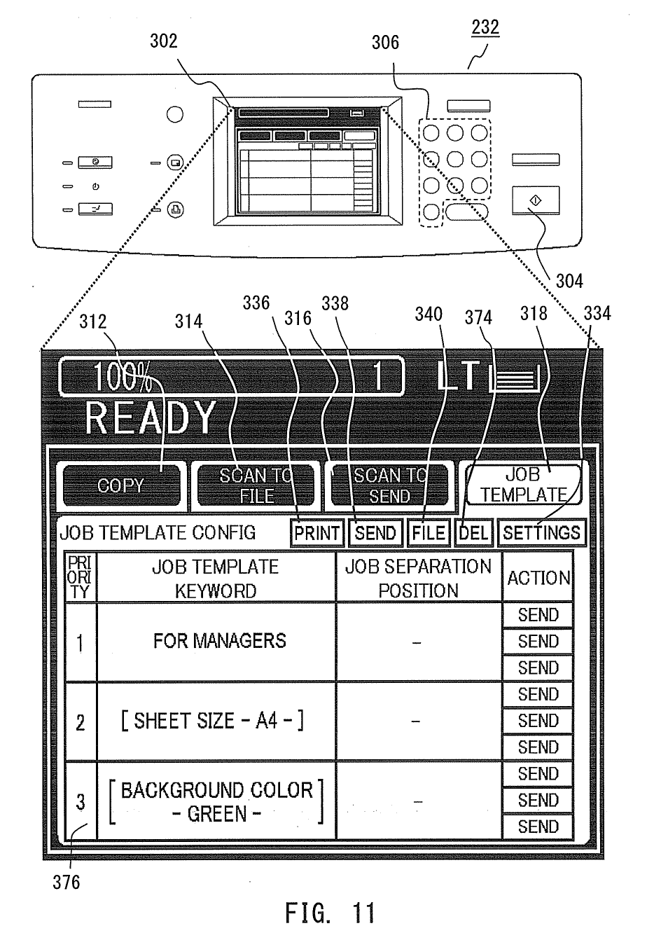

FIG. 11 illustrates another exemplary diagram of the operation panel 232 displayed upon pushing the job template config button 328. The operation panel 232 displays a table 376 indicating exemplary association of job template keywords, job separation position and an action. A phrase “FOR MANAGERS” is associated with a plurality of “SEND” actions without a sign of job separation position in the table 376. Each of the plurality of “SEND” actions can be associated with different e-mail addresses, respectively. Therefore, a plurality of e-mail addresses and telephone numbers can be associated with a single phrase.

Properties of a page may be associated with actions instead of, or with, job template keywords. A size of a page “A4” is associated with a plurality of “SEND” actions without a sign of job separation position in the table 376. A background color of a page “GREEN” is associated with another plurality of “SEND” actions without a sign of job separation position in the table 376. Additional properties may have discrete sets of “SEND” actions.

An image file may be associated with actions instead of, or with, job template keywords as a job separation key image. For example, an image file may be associated by a path wherein the image file is stored.

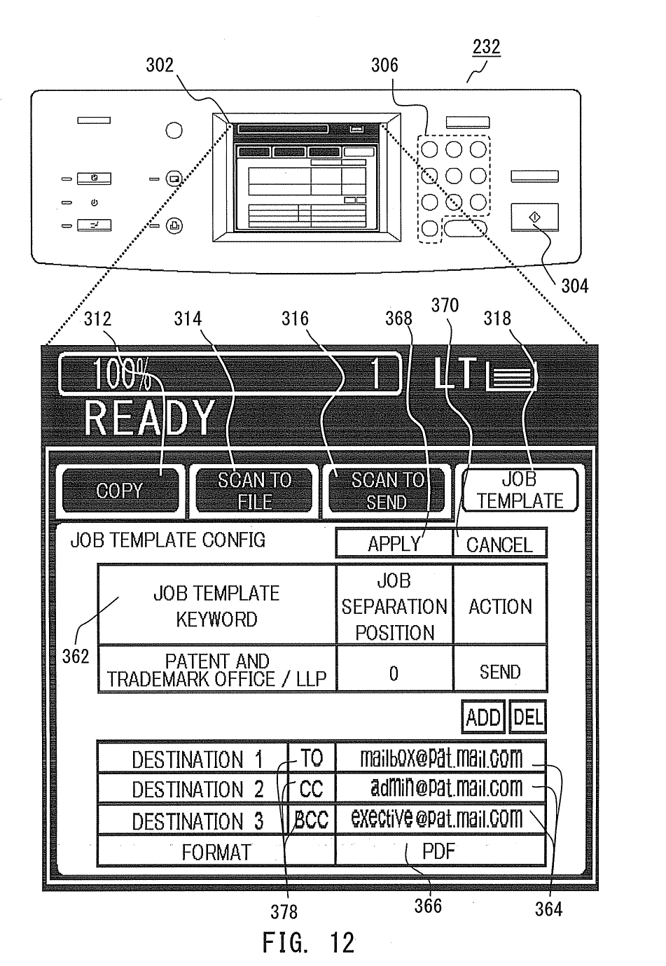

FIG. 12 illustrates another exemplary diagram of the configuration view for the send action. A plurality of e-mail addresses “mailbox@pat.mail.com”, “admin@pat.mail.com” and “executive@pat.mail.com” are associated with a phrase “PATENT AND TRADEMARK OFFICE/LLP”. The plurality of e-mail addresses “mailbox@pat.mail.com”, “admin@pat.mail.com” and “executive@pat.mail.com” are associated with e-mail destination attributes “TO”, “CC” and “BCC”, respectively. Telephone numbers can be used for sending faxes instead of the e-mail addresses. Both e-mail addresses and telephone numbers can be used in combination with each other.

The system controller 218 coordinates communications for the system processor 212, the system ROM 214, the system memory 216 and other components connected through the bus 220.

The storage interface 228 has a feature to write a data into, as well as to read the data out from, storage media including a controller-internal storage component such as the HDD 226 and a controller-external storage component such as a USB (Universal Serial Bus) storage 234. The storage interface 228 selects a storage component to communicate with according to an instruction produced by the system processor 212. The storage interface 228 exchanges the data with the system processor 212 via the bus 220 and the system controller 218.

The network adapter 230 connects to the network 116 to transmit information to and receive information from the image processing apparatus 104, the network file device 106 and the server 108.

The fax adapter 236 connects to the telecommunication network 120 to transmit information to and receive information from the fax machine 118.

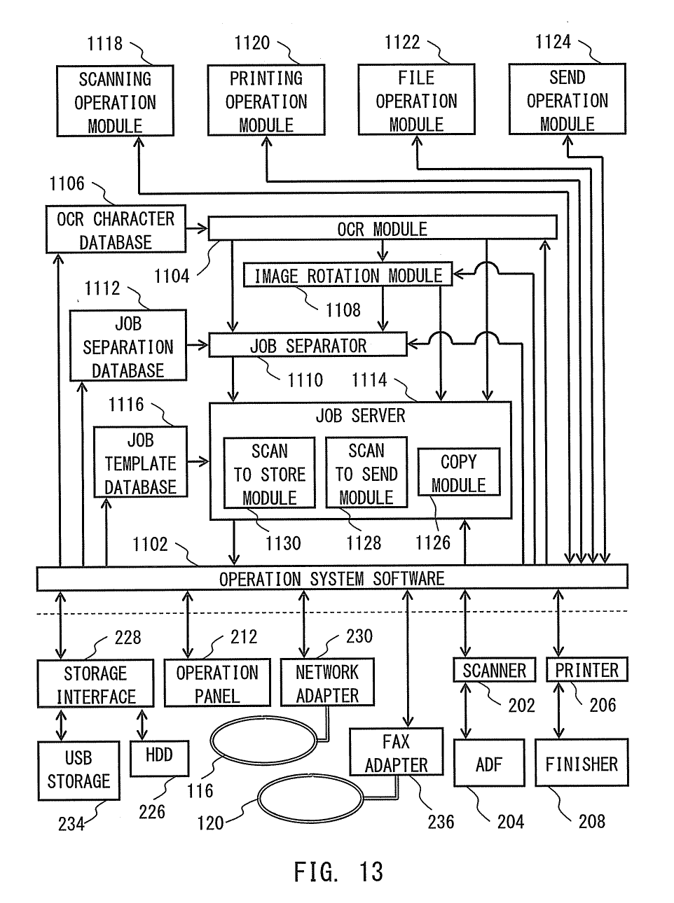

FIG. 13 illustrates an exemplary software system block diagram of an image processing apparatus 102. The software system includes an operation system software (OS) 1102, an OCR module 1104, an OCR character database 1106, an image rotation module 1108, a job separator 1110, a job separation database 1112, a job server 1114, a job template database 1116, a scanning operation module 1118, a printing operation module 1120, a file operation module 1122 and a send operation module 1124.

The HDD 226 may store software that acts as the software system. The software system may be distributed to the devices over the network 116.

The OS 1102 controls and communicates with hardware devices such as the storage interface 228, the network adapter 230, fax adapter 236, the operation panel 232, the printer 206 and the scanner 202.

The OS 1102 controls the finisher 208 through the printer 206, also. The OS 1102 may provide an instruction for finishing to the printer 206. The instruction may indicate to execute sorting, stapling, folding and processing a saddle-stitch in unit of a job.

The OS 1102 communicates the ADF 204 through the scanner 202. The OS 1102 may receive information whether a manuscript set on the ADF 204 includes a plurality of sheets or just a single sheet, from the ADF 204 through the scanner 202.

The OCR module 1104 communicates with the OS 1102 to refer the OCR character database 1106 and to obtain the raster image data in unit of page of the sheets to produce the character data. The OCR module 1104 may produce the character data with information indicating from which page the character data is produced. The OCR module 1104 may also produce information indicating from which region of the page the character data is produced. The region may be a header, a footer, a right and left region in the header or the footer, and so on. The OCR module 1104 looks up the raster image data in the OCR character database 1106. The OCR character database 1106 is stored in the HDD 226. The OCR character database 1106 may be read out through the OS 1102.

The OCR module 1104 may recognize an orientation of characters in the raster image data. The OCR module 1104 can employ ordinary techniques to recognize an orientation of text characters disclosed in U.S. Pat. No. 7,286,718 for example, which is hereby incorporated by reference.

The OCR module 1104 may obtain the scan image data instead of the raster image data, to produce the character data. The OCR module 1104 may obtain an intermediate image data produced during conversion from the scan image data to the raster image data, to produce the character data. The OCR module 1104 may use other data corresponding to the raster image data, to produce the character data.

The image rotation module 1108 communicates with the OCR module 1104 to obtain the raster image data in units of pages of sheets. The image rotation module 1108 may obtain the raster image data from the OS 1102. The image rotation module 1108 recognizes an orientation of the raster image data based on characteristics of the raster image data. The characteristics may be a direction of a straight line, an aspect of a rectangle object, or other graphic objects in the raster image data. The characteristics may use a graphic object dictionary which contains relational information between a graphic object and an angle. For example, the graphic object dictionary includes four triangle objects respectively rotated by 0, 90, 180 and 270 degrees associated with its rotated angles. The characteristics may be the orientation of a character recognized by the OCR module 1104. To determine the orientation, the image rotation module 1108 may refer the information indicating from which region of a page the character is produced. If the image rotation module 1108 determines that the orientation of a raster image represented by the raster image is correct, the image rotation module 1108 outputs the raster image data as is. If the image rotation module 1108 determines that the orientation of the raster image is rotated away from a correct orientation, the image rotation module 1108 converts the raster image data to represent a rotated raster image which is the raster image rotated to the correct orientation.

The job separator 1110 receives the raster image data serially in unit of page. The job separator 1110 may obtain the raster image data from the image rotation module 1108. The job separator 1110 obtains the character data in units of pages from the OCR module 1104.

The job separator 1110 delimits the raster image data according to the character data to create a group of pages. The group of pages is a job. The job separation database 1112 stores a rule to delimit the raster image data. The rule may be displayed on the operation panel 232 as the table 330. The job separator 1110 refers the rule to delimit the raster image data. The job separation database 1112 is stored in the HDD 226. The job separation database 1112 may be read out through the OS 1102.

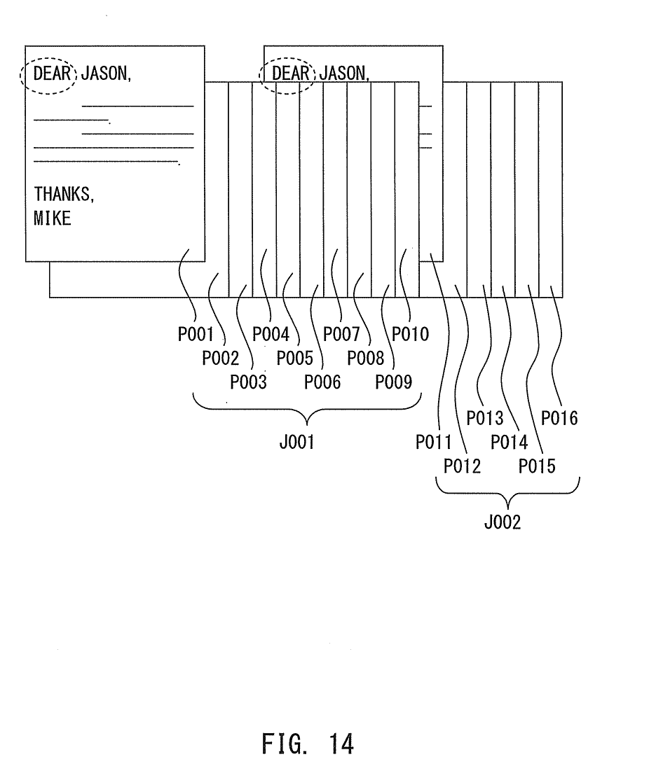

Based on the exemplary association between job separation keywords and job separation position on the table 330, for example, a word “DEAR” is associated with “0”. The word “DEAR” is the job separation keyword. The number “0” is a number of the job separation position. The job is separated in front of a page where the job separation keyword “DEAR” is found in as illustrated in FIG. 14. In FIG. 14, the word “DEAR” is written on a page P001 and a page P011 in serialized pages P001 through P016 without separation. In this situation, the serialized pages are separated in front of the page P001 and the page P011. Therefore, one job J001 includes the page P001 through a page P010, and another job J002 includes pages after the page P011.

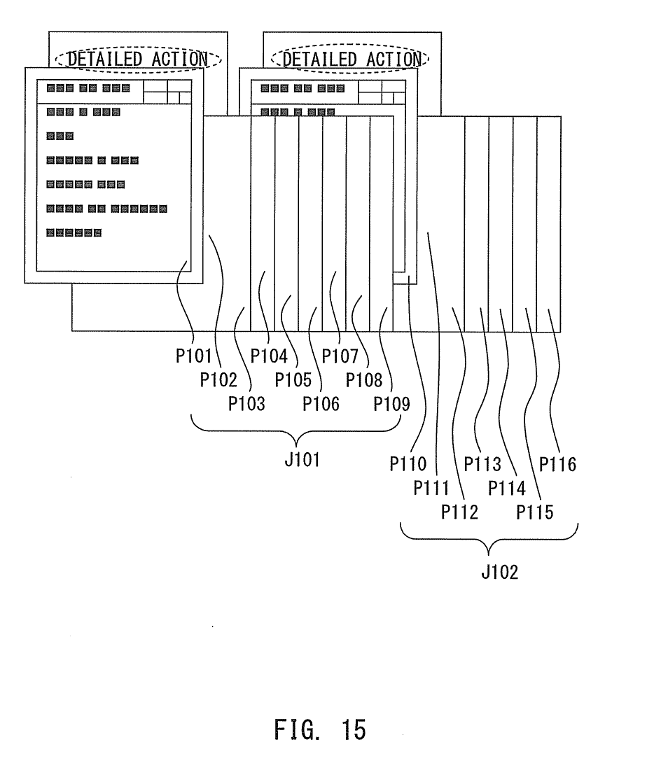

For another example, a phrase “DETAILED ACTION” is associated with “−1” on the table 330. By this rule, a new job starts from one page previously from a page where the job separation keyword “DETAILED ACTION” is found in as illustrated in FIG. 15. In FIG. 15, the word “DETAILED ACTION” is written on a page P102 and a page P111 in serialized pages P101 through P116 without separation. In this situation, the serialized pages are separated in front of the page P101 and the page P110. Therefore, one job J101 includes the page P101 through a page P109, and another job J102 includes pages after the page P110.

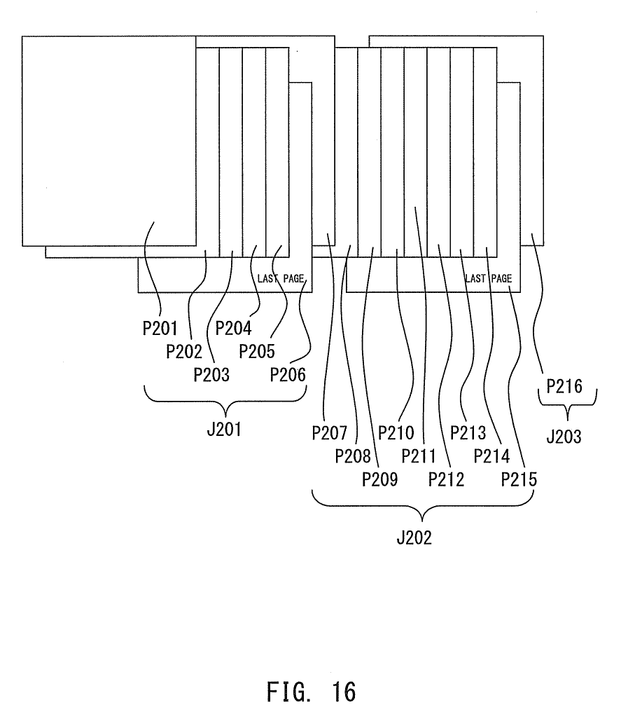

For another example, a phrase “LAST PAGE” is associated with “+1” on the table 330. By this rule, a new job starts on a page after a page where the job separation keyword “LAST PAGE” is found in as illustrated in FIG. 16. In FIG. 16, the word “LAST PAGE” is written on a page P206 and a page P215 in serialized pages P201 through P216. In this situation, the serialized pages are separated after the page P206 and the page P215. Therefore, first job J201 includes pages P201 through P206, second job J202 includes pages P207 through P215, and third job P203 includes a page P216.

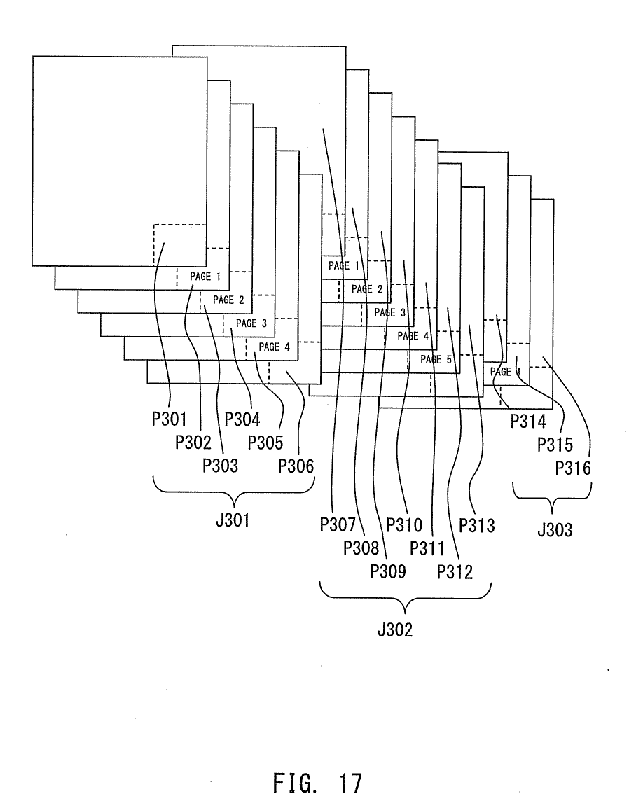

For another example, a phrase “PAGE# [AT RIGHT BOTTOM]” is associated with “+1 (RESERVE)” on the table 330. The character “#” means any numeral character. The statement “[AT RIGHT BOTTOM]” means a position in the page. By this rule, a start for new job is reserved as a position after a page where the job separation keyword “PAGE#” is found at right bottom of the page in as illustrated in FIG. 17. The right bottom region of the page may be in a rectangular illustrated with a broken line in FIG. 17. If the phrase “PAGE#” is found at right bottom of the next page, the reservation previously made is withdrawn and a start for new job is newly reserved as a position after the next page. That is, a job continues during the pages containing the job separation keyword “PAGE#” continue. If the phrase “PAGE#” is not found in the next page, the reservation previously made is executed to start new after the next page. In FIG. 17, the word “PAGE” is written at the left of a numeral character on pages P302 through P305, pages P308 through P312 and P315 in serialized pages P201 through P216 without separation. In this situation, the serialized pages are separated after page P306, page P313, and page P316. Therefore, the first job J301 includes pages P301 through P306, the second job J302 includes pages P307 through P313, and the third job P303 includes pages P314 through P316.

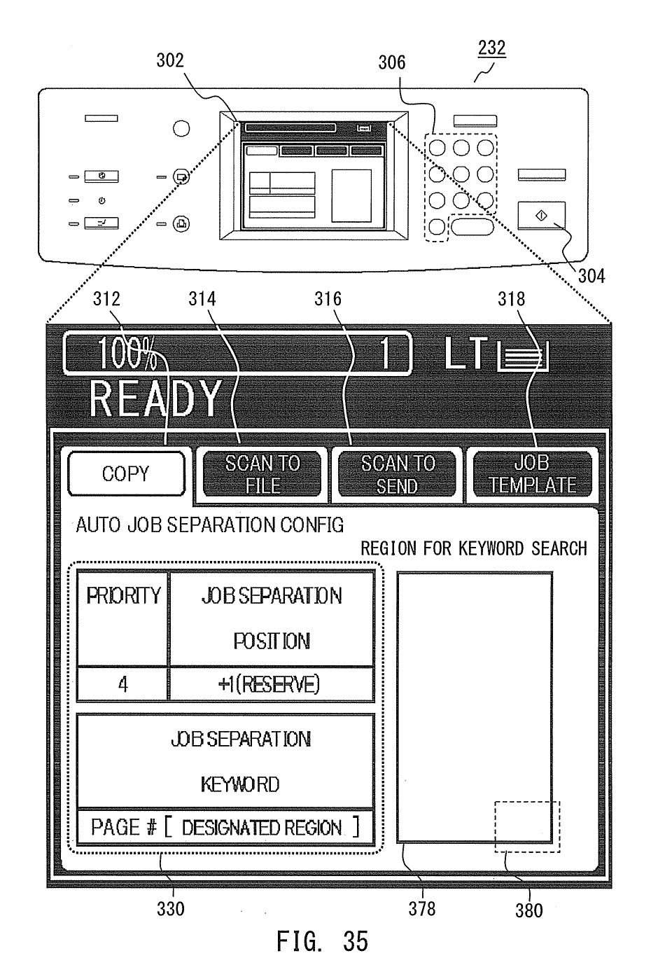

FIG. 35 illustrates another exemplary diagram of the operation panel 232 displayed upon pushing the auto job separation config button 322. The operation panel 232 may display an outline rectangle 378 indicating a page instead of such statement as “[AT RIGHT BOTTOM]” in the table 330 to designate the position in the page. The operation panel 232 may display a target rectangle 380 drawn with a broken line on the outline rectangle 378. The target rectangle 380 may indicate a region to search the job separation keyword on the page. The target rectangle 380 is positioned at right bottom of page in FIG. 35. Therefore, a start for new job is reserved as a position after a page where the job separation keyword “PAGE#” is found at right bottom of the page in as illustrated in FIG. 17.

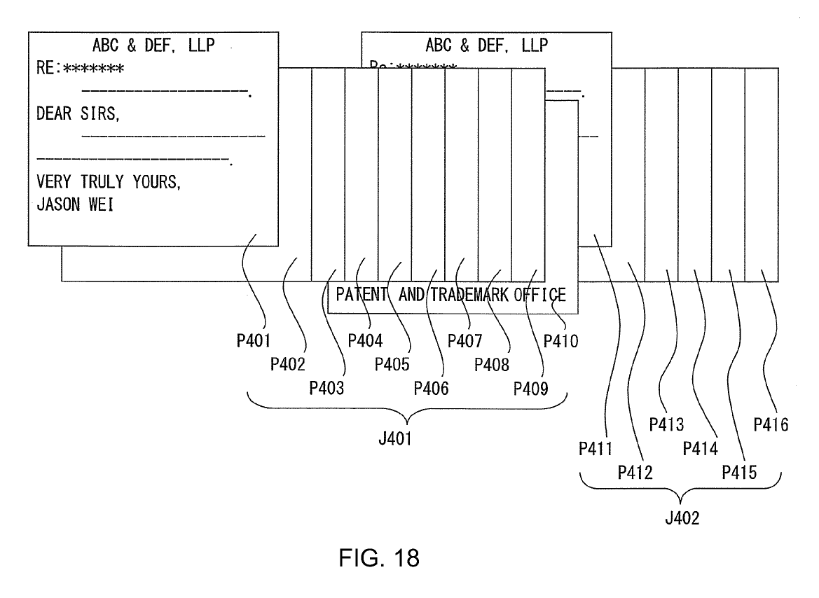

For another example, a phrase “PATENT AND TRADEMARK OFFICE/LLP” is associated with “0” on the table 330. By this rule, job separation is held between a page containing the word “PATENT AND TRADEMARK OFFICE” and a page containing the word “LLP” as illustrated in FIG. 18. In FIG. 18, the word “LLP” is written on a page P401 and a page P411, and the word “PATENT AND TRADEMARK OFFICE” is written on a page P410, in serialized pages P401 through P416. In this situation, the serialized pages are separated between the page P410 and the page P411. Therefore, first job J401 includes pages P401 through P410 and second job J402 includes page P411 through P416.

The job separation database 1112 includes information indicating such association between job separation keywords and job separation position. The job separation keywords may be not only words composed with letters as described above but also combinations of other graphic objects such as a logo, icon, letter heads, circle, triangles, rectangles and any other objects. The job separation keywords may be obtained by scanning documents to be stored in the job separation database 1112.

The job server 1114 receives the raster image data serially in unit of page. The job server 1114 may obtain the raster image data from at least one of the job separator 1110, the image rotation module 1108, and the OS 1102. The job server 1114 obtains the character data in unit of page from the OCR module 1104.

The job server 1114 deals the job in accordance with the character data and input from the operation panel 232. The job template database 1116 stores a rule to deal the job. The rule may be displayed on the operation panel 232 as the table 332. The job server 1114 looks up the character data in the job template database 1116. The job template database 1116 is stored in the HDD 226. The job template database 1116 may be read out through the OS 1102.

The job server 1114 includes job modules such as a copy module 1126, a scan to send module 1128 and a scan to store module 1130. The job server 1114 processes the job using the job modules according to the rule in the job template database 1116. The job modules communicate with operation modules such as the scanning operation module 1118, the printing operation module 1120, the file operation module 1122 and the send operation module 1124 through the OS 1102. The operation modules control the hardware devices through the OS 1102 to operate respective operations.

The job server 1114 executes the job in accordance with the exemplary association of job template keywords, job separation position, and an action on the table 332. For example, actions “SEND” and “FILE” are associated with no keyword on the table 332. The job server 1114 executes both of a send operation and a file operation for a job containing no keyword.

For another example, a word “DEAR” is associated with “0” and an action “FILE”. The word “DEAR” is the job template keyword. The number “0” is a number of the job separation position. The job is separated in front of a page where the job template keyword “DEAR” is found in as illustrated in FIG. 14 to create jobs J001 and J002, and a file operation is executed for both of the jobs J001 and J002.

For another example, a phrase “DETAILED ACTION” is associated with “−1” and actions “PRINT” and “FILE” on the table 332. By this rule, a new job starts from one page previously from a page where the job template keyword “DETAILED ACTION” is found in as illustrated in FIG. 15 to create jobs J101 and J102, and both of a print operation and the file operation are executed for both of the jobs J101 and J102.

For another example, a phrase “LAST PAGE” is associated with “+1” and an action “PRINT” on the table 332. By this rule, a new job starts on a page after a page where the job template keyword “LAST PAGE” is found in as illustrated in FIG. 16 to create jobs J201, J202 and J203, and a print operation is executed for each of the jobs J201 and J202. Both a send operation and a file operation are executed for the job J203 because the job J203 contains no keyword.

For another example, a phrase “PAGE#” is associated with “+1 (RESERVE)” and an action “PRINT” on the table 332. By this rule, a start for new job is reserved as a position after a page where the job template keyword “PAGE#” is found in as illustrated in FIG. 17 to create jobs J301, J302 and J303, and a print operation is executed for each of the jobs J301, J302, and J303.

For another example, a phrase “PATENT AND TRADEMARK OFFICE/LLP” is associated with “0” and actions “SEND” and “FILE” on the table 332. By this rule, a job separation is generated between a page containing the word “PATENT AND TRADEMARK OFFICE” and a page containing the word “LLP” as illustrated in FIG. 18 to create jobs J401 and J402, and both a send operation and a file operation are executed for each of the jobs J401 and J402.

For another example, a phrase “PRINT ALL” is associated with an action “PRINT” and no job separation position on the table 332. By this rule, a print operation is executed for the job without job separation.

For another example, an action “FILE” is cited on the table 332 with no job template keyword and no job separation position. By this rule, a file operation is executed without job separation for a job in which any job template keyword is found.

The job template database 1116 includes information indicating such association of job template keywords, job separation position and an action. The job template keywords may be not only words composed with letters as described above but also combinations of other graphic objects such as a circle, triangles, rectangles and any other objects. The actions may be not only the print operation, the send operation and the file operation but also other actions such as a facsimile operation.

(1) Exemplary Operation of an Image Processing Apparatus With Automatic Image Rotation

(1-1 Copying Operation With Automatic Image Rotation)

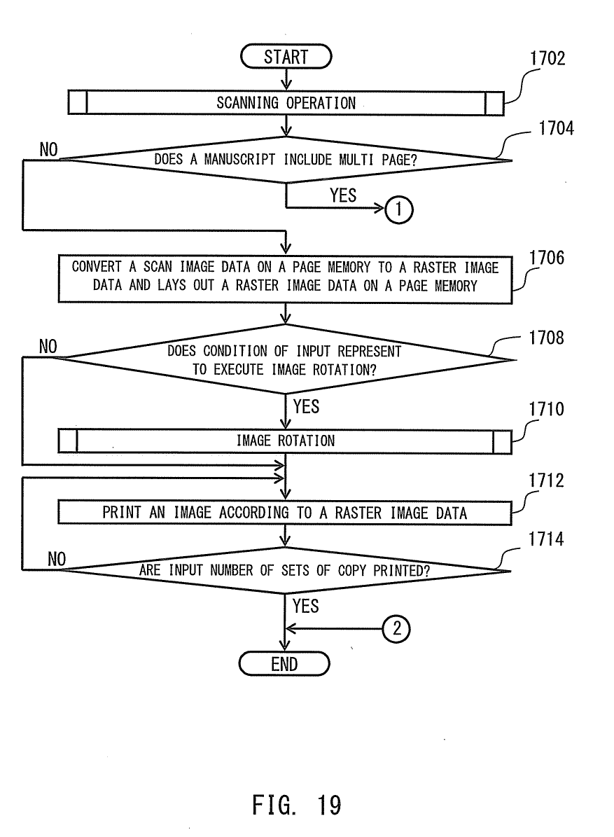

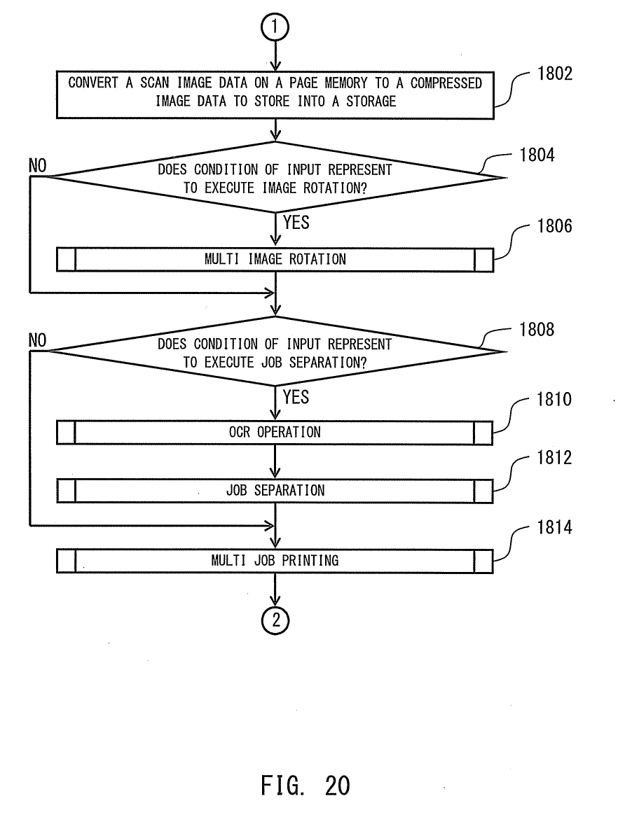

FIG. 19 and FIG. 20 illustrate flowcharts of an exemplary copying operation. The system processor 212 determines a direction for copying operation input from the operation panel 232 upon the execution button 304 on the operation panel 232 being pushed. The direction for copying operation input from the operation panel 232 may be such that the copy tab 312 is selected upon pushing the execution button 304. The system processor 212 interprets the direction according to the condition of input stored in the input memory space. The condition of input may be whether or not the auto image rotation mode button 324 is pushed and whether or not the auto job separation mode button 320 is pushed. The system processor 212 may determine to execute image rotation if the system processor 212 interprets that the auto image rotation mode button 324 is pushed. The system processor 212 may determine to execute job separation if the system processor 212 interprets that the auto job separation mode button 320 is pushed.

Upon the system processor 212 determines a direction for copying operation, the system processor 212 executes a scanning operation at 1702.

At 1704, the system processor 212 determines that whether a manuscript on the ADF 204 includes a plurality of sheets or just a single sheet according to detection by the ADF 204.

If the system processor 212 determines that the manuscript includes just a single sheet (reference “NO” of 1704), the image processor 222 converts the scan image data on the page memory 224 obtained in the scanning operation to a raster image data and lays out the raster image data on the page memory 224 at 1706.

If the system processor 212 determines that the condition of input represents executing image rotation (reference “YES” of 1708), the system processor 212 executes image rotation at 1710. The system processor 212 may execute OCR on the raster image data on the page memory 224 before the image rotation if the image rotation uses character data concerning the raster image.

The image processor 222 provides the raster image data on the page memory 224 to the printer 206. The printer 206 prints the image according to the raster image data at 1712.

If the system processor 212 determines that an input number of sets of copying, the input number may be the copy quantity input by the number keys 306 on the operation panel 232, are not yet printed, (reference “NO” of 1714), the act 1712 is executed again.

A circular terminal given a numeral “1” in FIG. 6 continues to a terminal given the same number on top of a flowchart in FIG. 20. If the system processor 212 determines that the manuscript includes a plurality of sheets (reference “YES” of 1704), the image processor 222 may convert scan image data on the page memory 224 obtained in the scanning operation to compressed image data to store into a storage at 1802. The storage may be the controller-internal storage component such as the HDD 226. The system processor 212 may execute OCR on the compressed image data stored in the storage.

If the system processor 212 determines that the condition of input represents executing image rotation (reference “YES” of 1804), the system processor 212 executes multi image rotation at 1806.

If the system processor 212 determines that the condition of input represents executing job separation (reference “YES” of 1808), the system processor 212 executes OCR on the compressed image data in the storage at 1809 and job separation at 1810. The OCR may be executed at between the act 1804 and the act 1806 instead of the act 1809 if the multi image rotation uses the character data produced by the OCR. The OCR may be executed at between the act 1802 and the act 1804 instead of the act 1809.

The system processor 212 executes multi job printing at 1812. A circular terminal given a numeral “2” in FIG. 7 continues to a terminal given the same number in FIG. 19.

(1-2 Scan to Store Operation With Automatic Image Rotation)

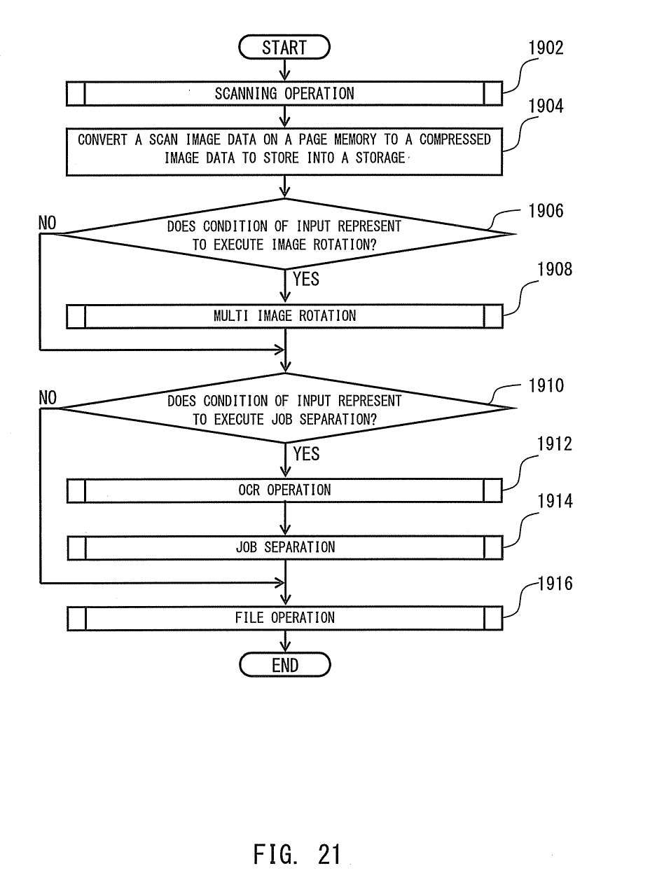

FIG. 21 illustrates a flowchart of an exemplary scanning to store operation. The system processor 212 determines a direction for scanning to store operation input from the operation panel 232 upon pushing the execution button 304 on the operation panel 232. The direction for scanning to store operation input from the operation panel 232 may be that the scan to file tab 314 is selected upon pushing the execution button 304. The system processor 212 interprets the direction according to the condition of input stored in the input memory space. The condition of input may be whether or not the auto image rotation mode button 324 is pushed and whether or not the auto job separation mode button 320 is pushed. The system processor 212 may determine to execute image rotation if the system processor 212 interprets that the auto image rotation mode button 324 is pushed. The system processor 212 may determine to execute job separation if the system processor 212 interprets that the auto job separation mode button 320 is pushed.

Upon the system processor 212 determining a direction for scanning to store operation, the system processor 212 executes a scanning operation at 1902.

The system processor 212 may convert a scan image data on the page memory 224 obtained in the scanning operation to compressed image data to store into a storage at 1904. The storage may be the controller-internal storage component such as the HDD 226. The system processor 212 may execute OCR on the compressed image data stored in the storage.

If the system processor 212 determines that the condition of input represents executing image rotation (reference “YES” of 1906), the system processor 212 executes multi image rotation at 1908.

If the system processor 212 determines that the condition of input represents executing job separation (reference “YES” of 1910), the system processor 212 executes OCR on the compressed image data in the storage at 1911 and job separation at 1912. The OCR may be executed at between the act 1906 and the act 1908 instead of the act 1911 if the multi image rotation uses the character data produced by the OCR. The OCR may be executed at between the act 1904 and the act 1906 instead of the act 1911.

The system processor 212 executes file operation at 1914.

(1-3 Scan to Send Operation With Automatic Image Rotation)

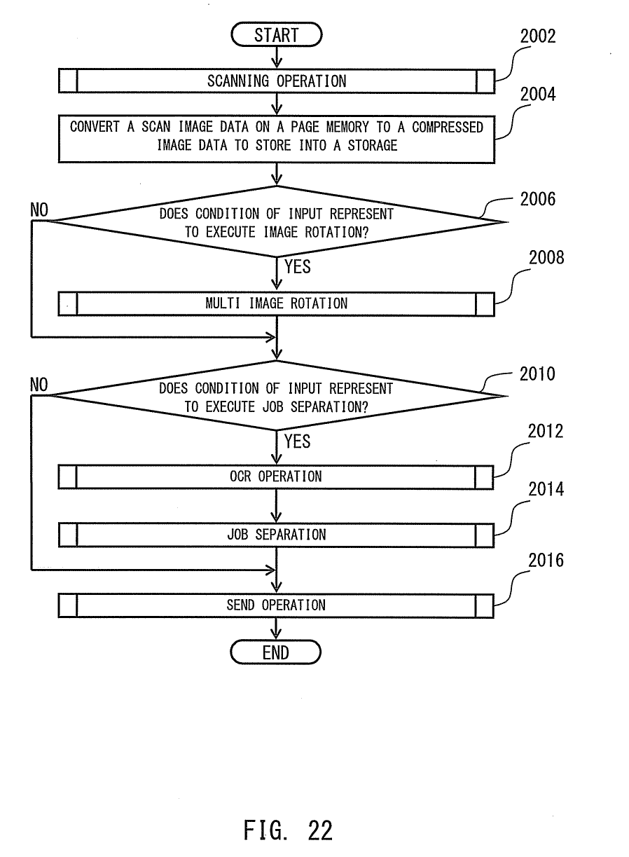

FIG. 22 illustrates a flowchart of an exemplary scanning to send operation. The system processor 212 determines a direction for scanning to send operation input from the operation panel 232 upon pushing the execution button 304 on the operation panel 232. The direction for scanning to store operation input from the operation panel 232 may be that the scan to send tab 316 is selected upon pushing the execution button 304. The system processor 212 interprets the direction according to the condition of input stored in the input memory space. The condition of input may be whether or not the auto image rotation mode button 324 is pushed and whether or not the auto job separation mode button 320 is pushed. The system processor 212 may determine to execute image rotation if the system processor 212 interprets that the auto image rotation mode button 324 is pushed. The system processor 212 may determine to execute job separation if the system processor 212 interprets that the auto job separation mode button 320 is pushed.

Upon the system processor 212 determining a direction for scanning to send operation, the system processor 212 executes a scanning operation at 2002.

The system processor 212 may convert a scan image data on the page memory 224 obtained in the scanning operation to a compressed image data to store into a storage at 2004. The storage may be the controller-internal storage component such as the HDD 226. The system processor 212 may execute OCR on the compressed image data stored in the storage.

If the system processor 212 determines that the condition of input represents executing image rotation (reference “YES” of 2006), the system processor 212 executes multi image rotation at 2008.

If the system processor 212 determines that the condition of input represents executing job separation (reference “YES” of 2010), the system processor 212 executes OCR on the compressed image data in the storage at 2011 and job separation at 2012. The OCR may be executed at between the act 2006 and the act 2008 instead of the act 2011 if the multi image rotation uses the character data produced by the OCR. The OCR may be executed at between the act 2004 and the act 2006 instead of the act 2011.

The system processor 212 executes send operation at 2014.

(1-4-1 Scanning Operation)

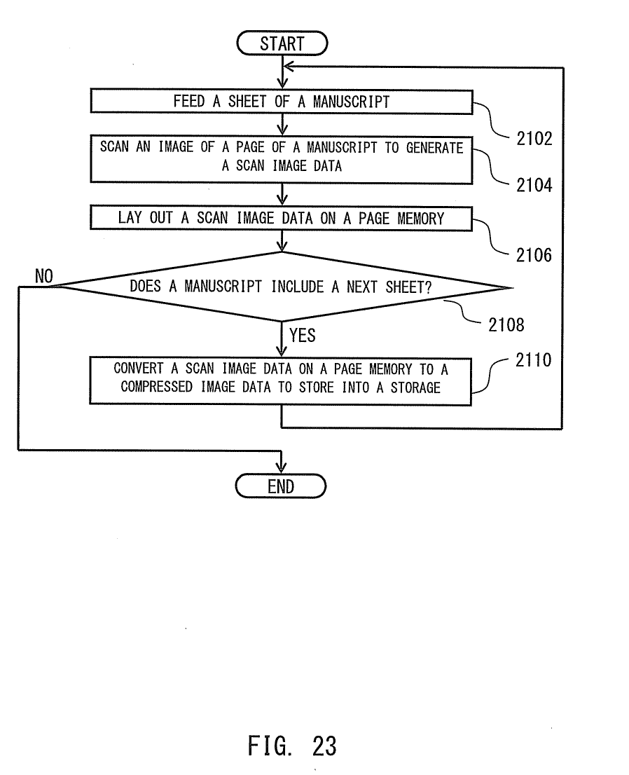

FIG. 23 illustrates a flowchart of an example of the scanning operation.

The scanner 202 lets the ADF 204 feed a first sheet of a manuscript to the scanner 202 at 2102. Concerned with the act 2102, the ADF 204 detects whether the manuscript includes a next sheet following the first sheet.

The scanner 202 scans the image of the sheet to generate scan image data at 2104.

The image processor 222 receives the scan image data from the scanner 202 and lays out the scan image data on the page memory 224 at 2106.

If the system processor 212 determines that the manuscript includes a next or following sheet (reference “YES” of 2108), the image processor 222 may convert the scan image data on the page memory 224 to compressed image data to store into a storage at 2110 and the act 2102 through the act 2106 are executed again. The storage may be the controller-internal storage component such as the HDD 226.

If the system processor 212 determines that the manuscript does not include any more sheets (reference “NO” of 2108), the system processor 212 finishes the scanning operation.

(1-4-2 Image Rotation)

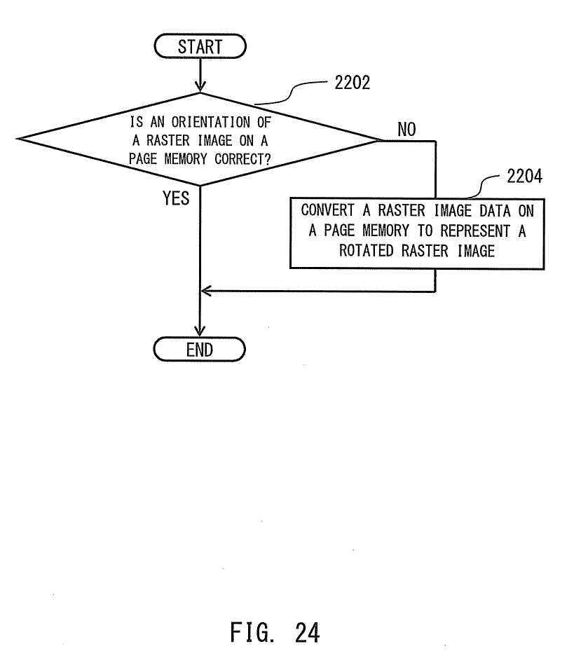

FIG. 24 illustrates a flowchart of an example of the image rotation.

At 2202, the system processor 212 determines an orientation of a raster image which the raster image data represents. If the system processor 212 determines that the orientation of the raster image is rotated from a correct orientation (reference “NO” of 2202), the system processor 212 converts the raster image data to represent a rotated raster image which is the raster image rotated to the correct orientation at 2204.

(1-4-3 Multi Image Rotation)

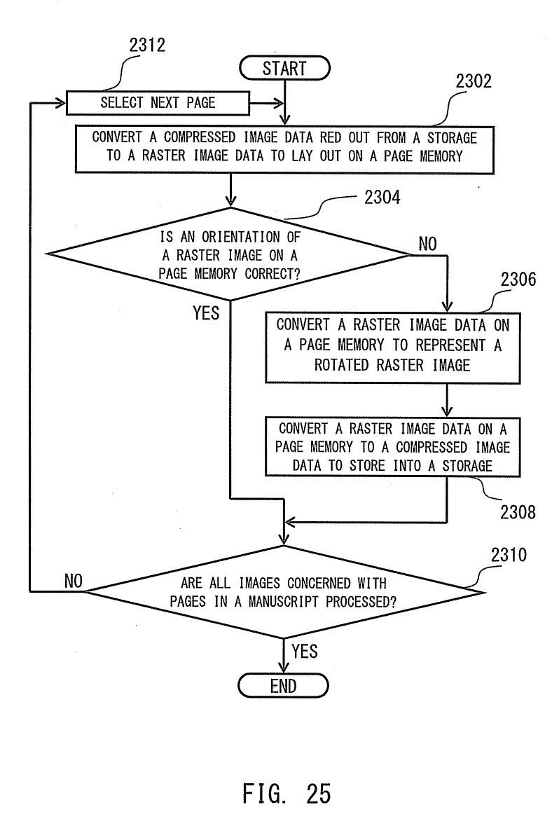

FIG. 25 illustrates a flowchart of an example of the multi image rotation.

The system processor 212 reads out compressed image data in a storage to a page memory 224 at 2302. The storage may be the controller-internal storage component such as the HDD 226. The system processor 212 converts the compressed image data into raster image data to lay out on the page memory 224.

The system processor 212 determines an orientation of a raster image of a page which the raster image data represents at 2304. If the system processor 212 determines that the orientation of the raster image of the page is rotated from a correct orientation (reference “NO” of 2304), the system processor 212 converts the raster image data to represent a rotated raster image which is the raster image of the page rotated to the correct orientation at 2306.

The system processor 212 converts the raster image data on the page memory 224 into compressed image data at 2308. The system processor 212 stores the compressed image data into the storage.

If the system processor 212 determines that all compressed image data associated with pages in a manuscript are not yet processed (reference “NO” of 2310), the act 2302 through the act 2310 are executed again for next page of the manuscript selected at 2312.

If the system processor 212 determines that all compressed image data associated with pages in the manuscript are processed (reference “YES” of 2310), the system processor 212 finishes the multi image rotation.

(1-4-4 Multi Job Printing)

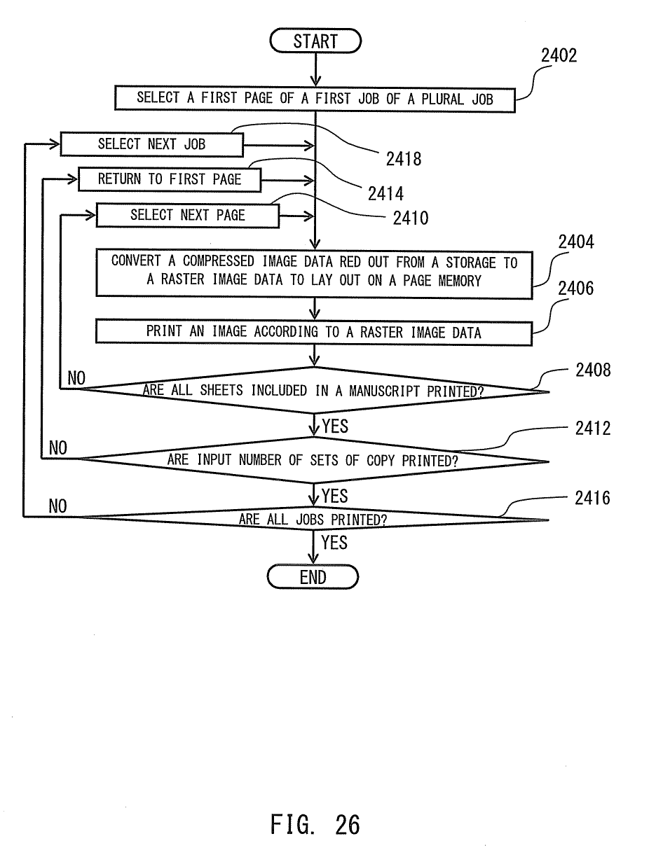

FIG. 26 illustrates a flowchart of an example of the multi job printing.

The image processor 222 selects a compressed image data of a first page of a first job of a plural job at 2402.

The image processor 222 converts the compressed image data read out from the storage to the raster image data to lay out on the page memory 224 at 2404. The storage may be the controller-internal storage component such as the HDD 226.

The image processor 222 provides the raster image data on the page memory 224 to the printer 206. The printer 206 prints the image according to the raster image data at 2406.

If the system processor 212 determines that all compressed image data associated with pages included in the job are not yet printed (reference “NO” of 2408), the act 2404 through the act 2406 are executed again for next page in the job selected at 2410. The job may be in units of a manuscript if the job separation is not executed. The manuscript may be separated to plural jobs if the job separation is executed on the manuscript.

If the system processor 212 determines that all compressed image data associated with pages included in the job are printed (reference “YES” of 2408), the system processor 212 determines whether input number of sets of copy are printed at 2412. If the system processor 212 determines that input number of sets of copy are not yet printed (reference “NO” of 2412), the act 2404 through the act 2408 are executed again for the job again from a compressed image data concerned with the first page of the job selected at 2414.

If the system processor 212 determines that input numbers of sets of copy are printed, (reference “YES” of 2412), the system processor 212 determines whether all jobs are printed at 2416. If the system processor 212 determines that all jobs are not yet printed (reference “NO” of 2416), the act 2404 through the act 2412 are executed again for next job selected at 2418.

If the system processor 212 determines that all jobs are printed, (reference “YES” of 2416), the system processor 212 finishes the multi job printing.

(1-4-5 File Operation)

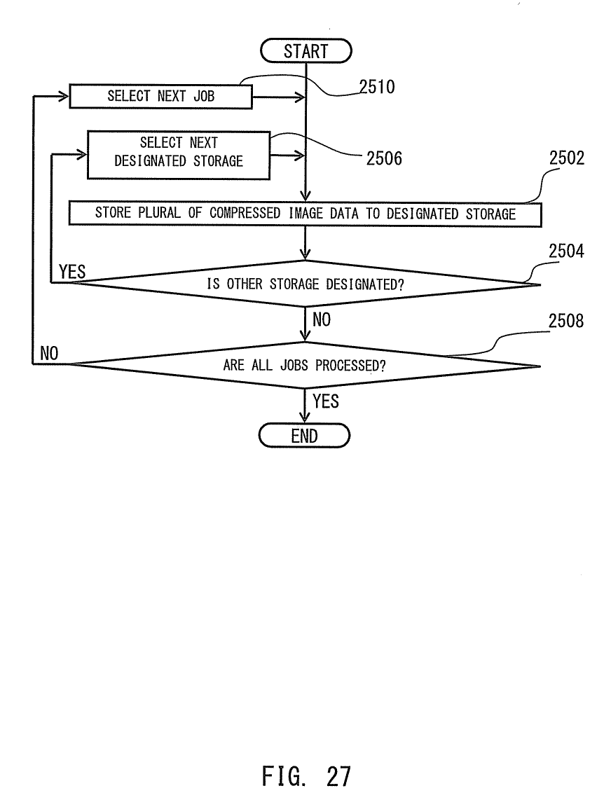

FIG. 27 illustrates a flowchart of an example of the file operation.

The system processor 212 determines a designated destination to store plural compressed image data concerned with a job. The job may be in units of a manuscript if the job separation is not executed. The manuscript may be separated to plural jobs if the job separation is executed on the manuscript. The system processor 212 stores the plural compressed image data associated with the job into the designated destination at 2502. The designated destination may be the controller-internal storage component such as one or more of the HDD 226, the controller-external storage component such as the USB storage 234, and other computing devices such as the image processing apparatus 104, the network file device 106, the server 108 as a data file server, the client computer 112 communicating via the network 116. The system processor 212 may store the plural compressed image data associated with the job into the designated destination as a file collectively.

The system processor 212 determines that other destination is designated for the plural compressed image data associated with the job at 2504. If the system processor 212 determines that other destination is designated for the plural compressed image data associated with the job (reference “YES” of 2504), the system processor 212 selects next designated destination to store the plural compressed image data concerned with the job at 2506 to execute the act 2502 again.

If the system processor 212 determines that no more destinations are designated for the plural compressed image data associated with the job (reference “NO” of 2504), the system processor 212 determines whether or not all jobs are processed at 2508.

If the system processor 212 determines that all jobs are not yet processed (reference “NO” of 2508), the act 2502 through the act 2504 are executed again for next job selected at 2510. If the system processor 212 determines that all jobs are processed (reference “YES” of 2508), the system processor 212 finishes the file operation.

(1-4-6 Send Operation)

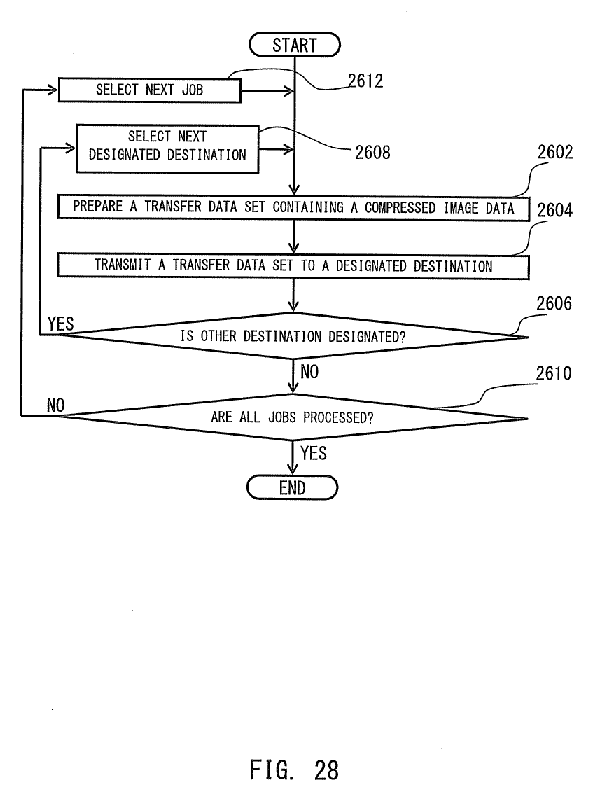

FIG. 28 illustrates a flowchart of an example of the send operation.

The system processor 212 determines a designated destination to send plural compressed image data associated with a job. The job may be in units of a manuscript if the job separation is not executed. The manuscript may be separated to plural jobs if the job separation is executed on the manuscript.

The system processor 212 prepares a transfer data set according to protocol at 2602. The transfer data set may contain the plural compressed image data associated with the job. The protocol may be one of an e-mail protocol or other protocol. The transfer data set may include at least one of destinations input as the character information by the character keyboard 308 on the operation panel 232.

The system processor 212 produces an instruction for the network adapter 230 to transmit the transfer data set at 2604. The network adapter 230 may transmit the transfer data set to a destination indicated in the transfer data set according to the protocol.

The system processor 212 determines that another destination is designated to send the plural compressed image data concerned with the job at 2606. If the system processor 212 determines that another destination is designated to send the plural compressed image data concerned with the job (reference “YES” of 2606), the system processor 212 selects the next designated destination to send the plural compressed image data concerned with the job at 2608 to execute the act 2602 and the act 2604 again. If the system processor 212 determines that no more destinations are designated to send the plural compressed image data concerned with the job (reference “NO” of 2606), the system processor 212 determines whether all jobs are processed at 2610. If the system processor 212 determines that all jobs are not yet processed (reference “NO” of 2610), the act 2602 through the act 2606 are executed again for next job selected at 2612. If the system processor 212 determines that all jobs are processed (reference “YES” of 2610), the system processor 212 finishes the send operation.

(1-4-7 OCR Operation)

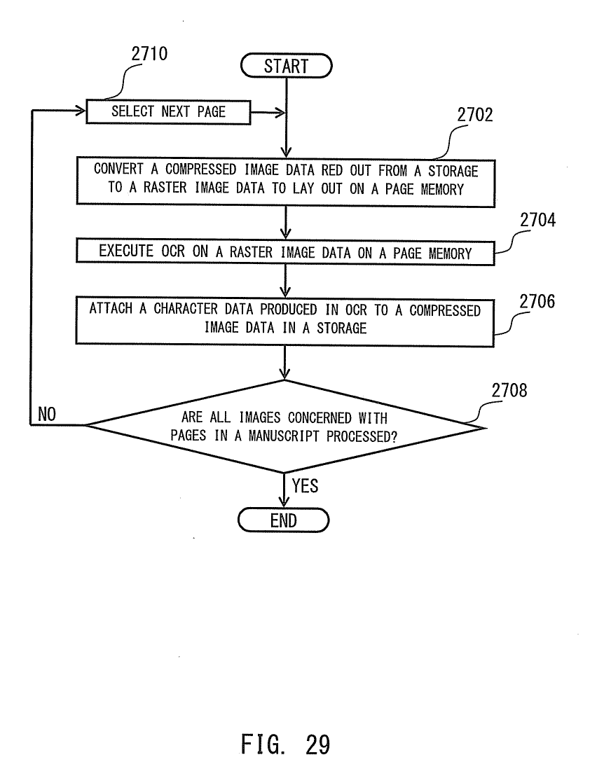

FIG. 29 illustrates a flowchart of an example of the OCR operation.

The system processor 212 reads out a compressed image data in a storage to a page memory 224 at 2702. The storage may be the controller-internal storage component such as the HDD 226. The system processor 212 converts the compressed image data to raster image data to lay out on the page memory 224.

The system processor 212 executes OCR on the raster image data on the page memory 224 to produce character data at 2704. At 2704, the job separation key image and the job template key image may be recognized on the raster data to produce a flag which indicate that the key image is found in the page. The flag may be used a part of the character data.

At 2706, The system processor 212 stores the character data into the storage to associate the character data with the compressed image data which is a source of the character data.

If the system processor 212 determines that all compressed image data concerned with pages in a manuscript are not yet processed (reference “NO” of 2708), the act 2702 through the act 2706 are executed again for next page of the manuscript selected at 2710.

If the system processor 212 determines that all compressed image data concerned with pages in the manuscript are processed (reference “YES” of 2708), the system processor 212 finishes the OCR operation.

(1-4-8 Job Separation)

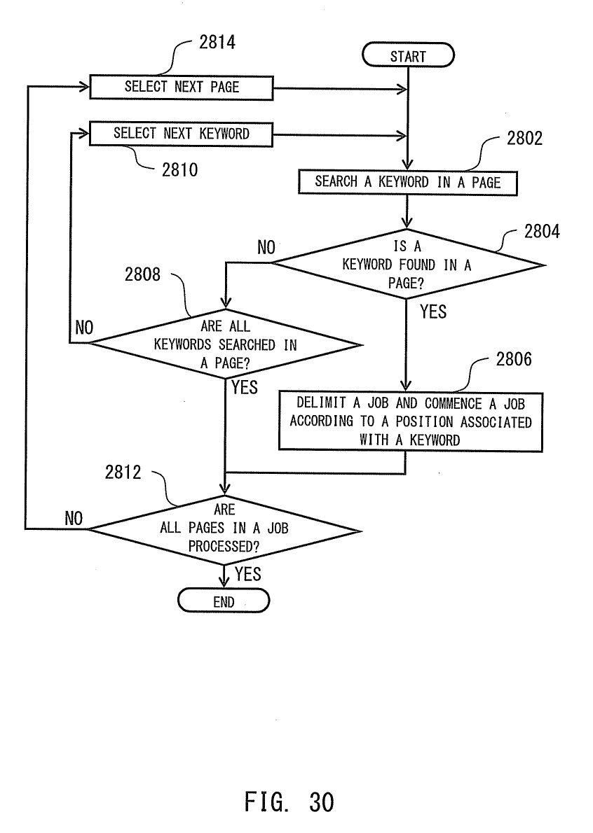

FIG. 30 illustrates a flowchart of an example of the job separation.

The system processor 212 searches a job separation keyword in character data associated with image data of a page included in a current job at 2802. The system processor 212 may search for a flag associated with a job separation key image in the character data associated with an image data of a page included in a current job at 2802. The system processor 212 searches for a job separation keyword and a flag of a job separation key image ranked as the lowest priority in the table 330. Hereinafter, the “job separation keyword” may mean both the job separation keyword and the flag of a job separation key image.

The system processor 212 determines whether or not the job separation keyword is found in the character data associated with the image data of the page at 2804. If the system processor 212 determines that the job separation keyword is found in the character data associated with the image data of the page (reference “YES” of 2804), the system processor 212 delimits the current job and commence a next job from a position according to a job separation position associated with the job separation keyword at 2806. If the system processor 212 determines that the job separation keyword is not found in the character data associated with the image data of the page (reference “NO” of 2804), the system processor 212 determines whether all of job separation keywords are searched in the character data associated with the image data of the page at 2808.

If the system processor 212 determines that all job separation keywords are not searched in the character data associated with the image data of the page (reference “NO” of 2808), the act 2802 is executed again with next job separation keyword selected at 2810. The system processor 212 selects a job separation keyword ranked as the next lowest priority in the table 330 at 2810.

If the system processor 212 determines that all job separation keywords are searched in the character data associated with the image data of the page (reference “YES” of 2808) or after the act 2806 is executed, the system processor 212 determines at 2812 whether all pages included in the current job before the job separation started are processed.

If the system processor 212 determines that all pages included in the current job before the job separation started are not yet processed (reference “NO” of 2812), the act 2802 is executed again for next page selected at 2814.

If the system processor 212 determines that all pages included in the current job before the job separation started are processed (reference “YES” of 2812), the system processor 212 finishes the job separation.

(1-5 Job Template Operation)

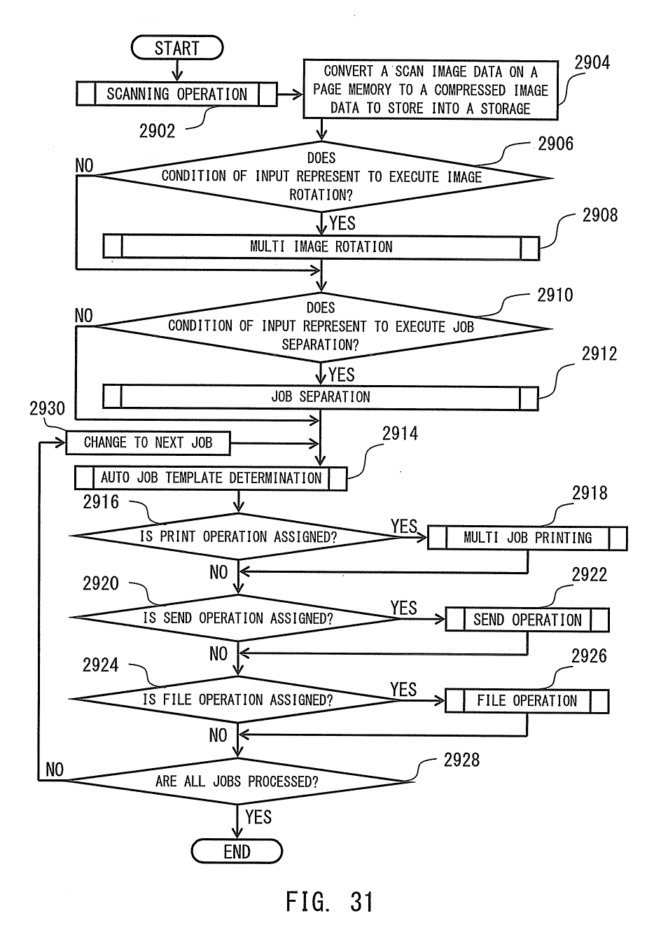

FIG. 31 illustrates a flowchart of an exemplary job template operation. The system processor 212 determines a direction for job template operation input from the operation panel 232 upon pushing the execution button 304 on the operation panel 232. The system processor 212 interprets the direction according to the condition of input stored in the input memory space. The condition of input may be one or more of whether or not the auto image rotation mode button 324 is pushed and whether or not the auto job separation mode button 320 is pushed. The system processor 212 may determine to execute image rotation if the system processor 212 interprets that the auto image rotation mode button 324 is pushed. The system processor 212 may determine to execute job separation if the system processor 212 interprets that the auto job separation mode button 320 is pushed.

Upon the system processor 212 determines a direction for job template operation, the system processor 212 executes a scanning operation at 2902.

At 2904, the system processor 212 may convert a scan image data on the page memory 224 obtained in the scanning operation to a compressed image data to store into a storage. The storage may be the controller-internal storage component such as the HDD 226.

If the system processor 212 determines that the condition of input represents executing image rotation (reference “YES” of 2906), the system processor 212 executes multi image rotation at 2908.

If the system processor 212 determines that the condition of input represents executing job separation (reference “YES” of 2910), the system processor 212 executes job separation at 2912.

The system processor 212 executes an auto job template determination at 2914.

If the system processor 212 determines that a print operation is assigned to the job in the auto job template determination (reference “YES” of 2916), the system processor 212 executes the multi job printing at 2918.

If the system processor 212 determines that a send operation is assigned to the job in the auto job template determination (reference “YES” of 2920), the system processor 212 executes the send operation at 2922.

If the system processor 212 determines that a file operation is assigned to the job in the auto job template determination (reference “YES” of 2924), the system processor 212 executes the file operation at 2926.

If the system processor 212 determines that all jobs are not yet processed (reference “NO” of 2928), the act 2914 through the act 2928 are executed again for next job selected at 2930.

If the system processor 212 determines that all jobs are processed (reference “YES” of 2928), the system processor 212 finishes the job template operation.

(1-5-1 Auto Job Template Determination)

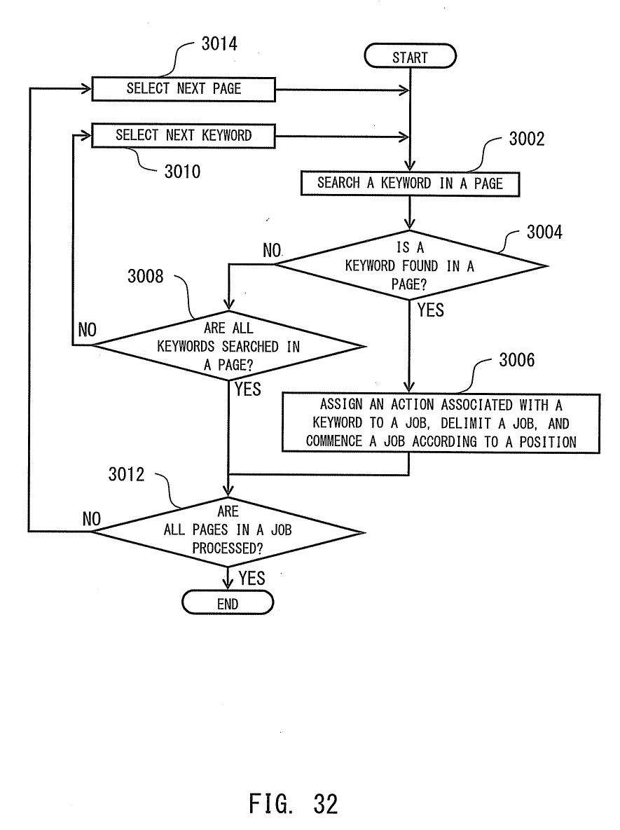

FIG. 32 illustrates a flowchart of an example of the auto job template determination. The system processor 212 searches a job template keyword in character data associated with image data of a page included in a current job at 3002. The system processor 212 may search for a flag associated with a job template key image in the character data associated with an image data of a page included in a current job at 3002. The system processor 212 searches for a job template keyword and a flag of a job template key image ranked as lowest priority in the table 332. Hereinafter, the “job template keyword” may mean both the job template keyword and the flag of a job template key image.

The system processor 212 determines whether the job template keyword is found in the character data associated with the image data of the page at 3004. If the system processor 212 determines that the job template keyword is found in the character data associated with the image data of the page (reference “YES” of 3004), the system processor 212 assigns an action associated with the job template keyword in the table 332, and delimits the current job and commence a next job from a position according to a job template position associated with the job template keyword at 3006. According to the table 332 shown in FIG. 7, the job template keyword “−” means that the system processor 212 determines the job template keyword is found at 3004 regardless of whether or not the job template keyword is found in the character data associated with the image data of the page.

If the system processor 212 determines that the job template keyword is not found in the character data associated with the image data of the page (reference “NO” of 3004), the system processor 212 determines whether all job template keywords are searched in the character data associated with the image data of the page at 3008.

If the system processor 212 determines that all job template keywords are not searched in the character data associated with the image data of the page (reference “NO” of 3008), the act 3002 is executed again with next job template keyword selected at 3010. The system processor 212 selects a job template keyword ranked as the next lowest priority in the table 332 at 3010.

If the system processor 212 determines that all job template keywords are searched in the character data associated with the image data of the page (reference “YES” of 3008) or after the act 3006 is executed, the system processor 212 determines at 3012 whether all pages included in the current job before the job separation started are processed.

If the system processor 212 determines that all pages included in the current job before the job separation started are not yet processed (reference “NO” of 3012), the act 3002 is executed again for next page selected at 3014.

If the system processor 212 determines that all pages included in the current job before the job separation started are processed (reference “YES” of 3012), the system processor 212 finishes the auto job template determination.

(1-6 Job Template Operation for a File)

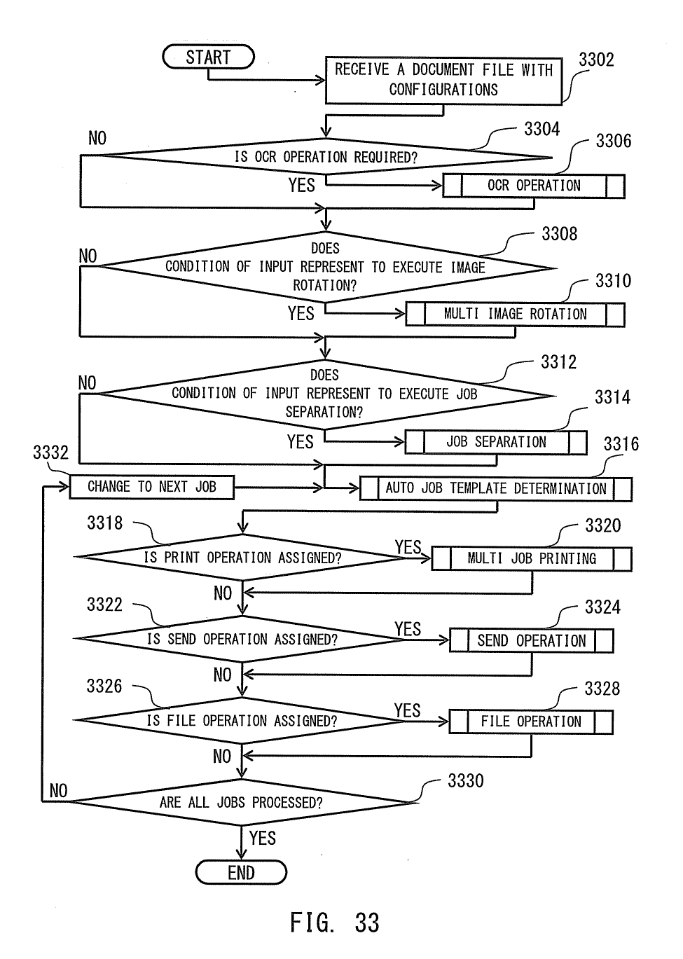

FIG. 33 illustrates a flowchart of an exemplary job template operation for a file including a plurality of pages. Designation of a file is executed instead of the scanning operation in the job template operation for a file.

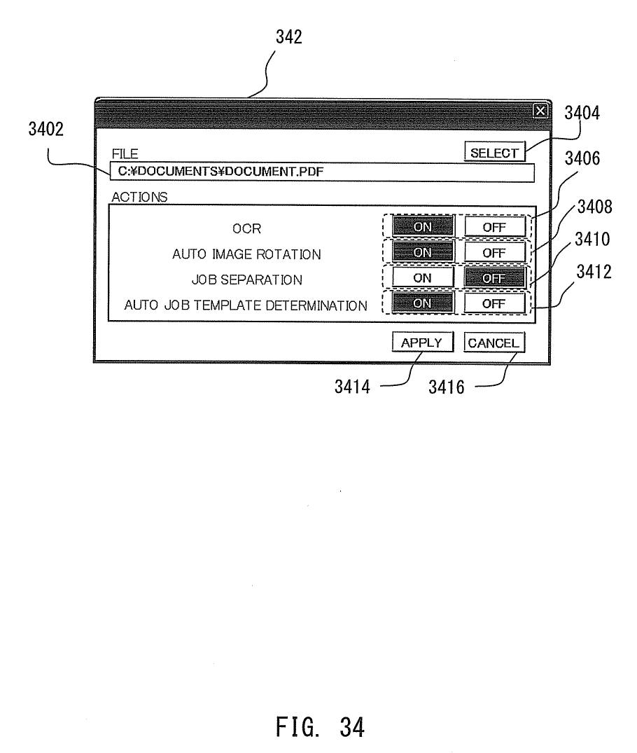

The client computer 112 may display a control window 342 illustrated in FIG. 34. The control window 342 may have one or more of a file designation field 3402, a file explorer button 3404, OCR buttons 3406, auto image rotation buttons 3408, job separation buttons 3410, auto job template determination button 3412, an apply button 3414 and a cancel button 3416.

A path of the file is input into the file designation field 3402. The file explorer button 3404 may call a file explorer to help selecting the file from a file system. The OCR buttons 3406 are to input whether or not the OCR operation is applied to the file. The auto image rotation buttons 3408 is to input whether or not the auto image rotation is applied to the file. The job separation buttons 3410 is to input whether or not the job separation is applied to the file. The auto job template determination button 3412 is to input whether or not the auto job template determination is applied to the file.

The client computer 112 sends a direction for the job template operation for a file upon the apply button 3414 being activated. The direction may include one or more of the path input into the file designation field 3402 and information about the input from the OCR buttons 3406, the auto image rotation buttons 3408, the job separation buttons 3410 and the auto job template determination button 3412. If the cancel button 3416 is activated, the control window 342 may be closed.

In the image processing apparatus 1, the system processor 212 determines the direction received through the network 116 at 3304. The system processor 212 interprets the direction.

If the system processor 212 determines that the direction represents to execute OCR operation (reference “YES” of 3304), the system processor 212 executes the OCR operation at 3306. The OCR operation may not be executed if the file already includes character data. The character data included in the file can be used instead of character data generated by the OCR operation.

If the system processor 212 determines that the direction represents executing image rotation (reference “YES” of 3308), the system processor 212 executes multi image rotation at 3310.

If the system processor 212 determines that the direction represents executing job separation (reference “YES” of 3312), the system processor 212 executes job separation at 3314.

The system processor 212 executes an auto job template determination at 3316.

If the system processor 212 determines that a print operation is assigned to the job in the auto job template determination (reference “YES” of 3318), the system processor 212 executes the multi job printing at 3320.

If the system processor 212 determines that a send operation is assigned to the job in the auto job template determination (reference “YES” of 3322), the system processor 212 executes the send operation at 3324.

If the system processor 212 determines that a file operation is assigned to the job in the auto job template determination (reference “YES” of 3326), the system processor 212 executes the file operation at 3328.

If the system processor 212 determines that all jobs are not yet processed (reference “NO” of 3330), the act 3316 through the act 3330 are executed again for next job selected at 3332.

If the system processor 212 determines that all jobs are processed (reference “YES” of 3330), the system processor 212 finishes the job template operation for a file.

A plurality of files may be selected at the client computer 112. If the plurality of files are selected, the act 3304 through the act 3332 may be applied to an aggregation of the plurality of files. All pages included in the plurality of files may be dealt as pages in a file in the aggregation.

Such configuration as described above may provide methods of an automatic/intelligent scan template selection, an automatic/intelligent scan destination routing based on information that a scanned document contains, an automatic scan job separation, and/or an automatic image rotation/correction.

Using the automatic/intelligent scan template selection and the automatic/intelligent scan destination may retrieve keywords from the scanned documents and may match the keywords to pre-defined scan destinations and templates.

Using the automatic scan job separation, a user can put all sets of the documents on the ADF and start scanning at once. A different set of documents can be separated automatically and can be sent to same or different destinations accordingly. Incorrectly placed documents can be automatically flipped to the correct direction.

Using the automatic image rotation/correction, the incorrectly placed documents can be automatically flipped to the correct direction.

Such configuration as described above may automate tedious, error-prone and repeated steps that users may go through to scan in image, invoices, receipts, and any other documents. Such configuration as described above may dramatically reduce a time which a user spends on using and occupying the scanning system, therefore, improves users' productivity and maximize usage of the scanning system.

As used in this application, entities for executing the actions exemplary described as “module” can refer to a computer-related entity, either hardware, a combination of hardware and software, software, or software in execution. For example, an entity for executing an action can be, but is not limited to being, a process running on a processor, a processor, an object, an executable, a thread of execution, a program, and a computer. By way of illustration, both an application running on a document processing machine and the document processing machine can be an entity. One or more entities can reside within a process and/or thread of execution and an entity may be localized on one document processing machine and/or distributed between two or more document processing machines.

There are multiple ways of implementing the invention, e.g., an appropriate API, tool kit, driver code, operating system, control, standalone or downloadable software object, etc. which enables applications and services to use the techniques of the invention. The claimed subject matter contemplates the use from the standpoint of an API (or other software object), as well as from a software or hardware object that operates according to the techniques in accordance with the invention. Thus, various implementations of the innovation described herein may have aspects that are wholly in hardware, partly in hardware and partly in software, as well as in software.

Generally, program modules include routines, programs, components, data structures, etc., that perform particular tasks or implement particular abstract data types. Moreover, those skilled in the art will appreciate that the inventive methods and devices can be practiced with other system configurations, including single-processor or multiprocessor systems, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

An image processing apparatus typically includes a variety of computer readable media. Computer readable media can be any available media that can be accessed by the image processing apparatus and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the image processing apparatus.

Although the description of computer-readable media above refers to a HDD, it should be appreciated by those skilled in the art that other types of media which are readable by a computer, such as removable magnetic diskette, CDs, DVDs, zip drives, magnetic cassettes, flash memory cards, cartridges, and the like, may also be used in the illustrative operating environment, and further, that any such media may contain executable instructions for performing the methods of the disclosed and claimed subject matter.

Although the invention is shown and described with respect to certain illustrated aspects, it will be appreciated that equivalent alterations and modifications will occur to others skilled in the art upon the reading and understanding of this specification and the annexed drawings. In particular regard to the various functions performed by the above described components, the terms used to describe such components are intended to correspond, unless otherwise indicated, to any component which performs the specified function of the described component (e.g., that is functionally equivalent), even though not structurally equivalent to the disclosed structure, which performs the function in the herein illustrated exemplary aspects of the invention.

What is claimed is:

1. An image processing apparatus, comprising:
an input module configured to input an image and first character data, the first character data being associated with the image;
a template database module configured to store a template, the template comprising information of an operation associated with second character data;
a determination module configured to determine the template according to the first character data and the second character data; and
a job server module configured to execute the operation included in the template for the image.

2. The apparatus of claim 1, wherein the input module comprises a scanning module configured to scan a sheet document to generate the image, and an OCR module configured to generate the first character data from the image.

3. The apparatus of claim 1, wherein the input module comprises an auto document feeder configured to feed sheet documents sequentially, a scanning module configured to scan the sheet documents sequentially fed by the auto document feeder to generate a series of images including the image, an OCR module configured to generate the first character data from the image and to generate first character data for each of the series of images, and a storage configured to store the series of images with the first character data.

4. The apparatus of claim 3, wherein the determination module determines the template according to the first character data and the second character data after all of the series of images are stored in the storage.

5. The apparatus of claim 1, wherein the operation comprises printing the image.

6. The apparatus of claim 1, wherein the operation comprises sending the image via e-mail to a plurality of destinations.

7. The apparatus of claim 1, wherein the operation comprises storing the image to a plurality of destinations.

8. The apparatus of claim 1, further comprising a network interface configured to communicate with a server.

9. The apparatus of claim 8, wherein the operation comprises sending the image via e-mail to a plurality of destinations, and the network interface communicates with the server to send the e-mail.

10. The apparatus of claim 8, wherein the operation comprises storing the image to a plurality of destinations, and the network interface communicates with the server to store the image into the server.

11. The apparatus of claim 1, wherein the template comprises information of an operation associated with a plurality of sets of second character data.

12. The apparatus of claim 11, wherein different destinations are respectively associated with each of the plurality of sets of second character data.

13. The apparatus of claim 1, wherein the template includes a set of second character data associated with information of a plurality of operations.

14. The apparatus of claim 13, wherein the plurality of operations comprise substantially identical operations for different destinations.

15. The apparatus of claim 1, wherein the input module inputs a series of images and a plurality of sets of first character data as a job, the plurality of sets of the first character data being respectively associated with each of the series of images.

16. The apparatus of claim 15, further comprising:
a job separation module configured to separate the job into a first new job and a second new job, the first new job including a part of the series of images;
wherein the template database module stores a template, the template comprising information of an operation associated with a set of second character data, the determination module determines the template based on at least one of the plurality of sets of first character data associated with at least one of the images included in the first new job and the second character data, and the job server module executes the operation included in the template for the first new job.

17. The apparatus of claim 16, wherein the template database module stores a plurality of templates, the templates comprising information of operations respectively associated with each of a plurality of sets of second character data, the determination module determines at least one of the plurality of templates based on at least one of the plurality of sets of first character data associated with at least one of the series of images included in the first new job and the plurality of sets of second character data, and the job server module executes an operation included in the one of the plurality of templates determined by the determination module for the first new job.

18. The apparatus of claim 16, wherein the determination module selects a first template from the plurality of templates based on at least one of the plurality of sets of first character data associated with at least one of the series of images included in the first new job and the plurality of sets of second character data, the determination module further selects a second template from the plurality of templates based on at least one of the plurality of sets of first character data associated with at least one of the series of images included in the second new job and the plurality of sets of second character data, and the job server module executes an operation included in the first template for the first new job and an operation included in the second template for the second new job.

19. An image forming apparatus, comprising:
an input module configured to input an image and first character data, the first character data being associated with the image;
a template database module configured to store a template, the template comprising information of an operation associated with second character data;
a determination module configured to determine the template according to the first character data and the second character data;
a job server module configured to create a print direction based on the operation included in the template for the image; and
a printer configured to print the image based on the print direction.

20. An image processing method, comprising:
inputting an image and first character data, the first character data being associated with the image;
determining a template according to the first character data and a second character data, the template comprising information of an operation associated with the second character data; and
executing the operation included in the template for the image.
